(19) United States
(12) Patent Application Publication
(10) Pub. No.: US 2024/0103632 A1
(43) Pub. Date: Mar. 28, 2024

(54) PROBABILISTIC GESTURE CONTROL WITH FEEDBACK FOR ELECTRONIC DEVICES

(71) Applicant: Apple Inc., Cupertino, CA (US)

(72) Inventors: Matthias R. HOHMANN, Mountain View, CA (US); Anna SEDLACKOVA, San Francisco, CA (US); Bradley W. GRIFFIN, Aptos, CA (US); Christopher M. SANDINO, Menlo Park, CA (US); Darius A. SATONGAR, Staffordshire (GB); Erdrin AZEMI, San Mateo, CA (US); Kaan E. DOGRUSOZ, San Francisco, CA (US); Paul G. PUSKARICH, Palo Alto, CA (US); Gergo PALKOVICS, Seattle, WA (US)

(21) Appl. No.: 18/369,833

(22) Filed: Sep. 18, 2023

Related U.S. Application Data
(60) Provisional application No. 63/409,638, filed on Sep. 23, 2022.

(51) Int. Cl. G06F 3/01; G06F 3/0346

(52) U.S. Cl. CPC G06F 3/017; G06F 3/0346; G06F 3/011; G06F 3/016

(57) ABSTRACT

Aspects of the subject technology relate to providing gesture-based control of electronic devices. Providing gesture-based control may include determining, with a machine learning system that includes multiple machine learning models, a prediction of one or more gestures and their corresponding probabilities of being performed. A likelihood of the user's intent to actually perform that gesture may then be generated, based on the prediction and a gesture detection factor. The likelihood may be dynamically updated over time, and a visual, auditory, and/or haptic indicator of the likelihood may be provided as user feedback. The visual, auditory, and/or haptic indicator may be helpful to guide the user to the correct gesture if the gesture is intended, or to stop performing an action similar to the gesture if the gesture is not intended.

### CROSS REFERENCE TO RELATED APPLICATIONS

This application claims the benefit of priority to U.S. Provisional Patent Application No. 63/409,638, entitled, “Probabilistic Gesture Control With Feedback For Electronic Devices,” filed on Sep. 23, 2022, the disclosure of which is hereby incorporated herein in its entirety.

### TECHNICAL FIELD

The present description relates generally to gesture-based control of electronic devices, including, for example, probabilistic gesture control with feedback for electronic devices.

### BACKGROUND

Electronic devices such as wearable electronic devices are often provided with input components such as keyboards, touchpads, touchscreens, or buttons that enable a user to interact with the electronic device. In some cases, an electronic device can be configured to accept a gesture input from a user for controlling the electronic device.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates an example device that may implement a system for gesture control in accordance with one or more implementations.

FIG. 3 illustrates a perspective view of an example electronic device in accordance with one or more implementations.

FIG. 4 illustrates a use case in which a gesture likelihood determined by a first electronic device is used to generate a visual indicator on another electronic device in accordance with one or more implementations.

FIG. 5 illustrates a use case in which the gesture likelihood of FIG. 4 has met a threshold for activation of gesture control in accordance with one or more implementations.

FIG. 6 illustrates a use case in which the gesture likelihood of FIG. 5 no longer meets the threshold for activation of gesture control due to a release of a gesture in accordance with one or more implementations.

FIG. 7 illustrates an example process and system for probabilistic gesture control in accordance with one or more implementations.

FIG. 8 illustrates an example of a dynamically updating visual indicator with distinct visual indicator components in accordance with one or more implementations.

FIG. 9 illustrates an example of a visual indicator with an orientation indicator in accordance with one or more implementations.

FIG. 10 illustrates an example of a motion-sensitive variable gesture detection threshold in accordance with one or more implementations.

FIG. 11 illustrates an example of weight and temporal-smoothing modifications for gesture control in accordance with one or more implementations.

FIG. 12 illustrates an example process and system for voice-assisted gesture control in accordance with one or more implementations.

FIG. 13 illustrates a flow chart of an example process for probabilistic gesture control in accordance with one or more implementations.

FIG. 14 illustrates a flow chart of an example process for providing a visual indicator for gesture control in accordance with one or more implementations.

FIG. 15 illustrates a flow chart of an example process for voice-assisted gesture control in accordance with one or more implementations.

FIG. 16 illustrates a flow chart of another example process for probabilistic gesture control in accordance with one or more implementations.

FIG. 17 illustrates a flow chart of an example process for probabilistic gesture control with visual feedback in accordance with one or more implementations.

FIG. 18 illustrates a flow chart of an example process for voice-assisted probabilistic gesture control with visual feedback in accordance with one or more implementations.

FIG. 19 is a block diagram illustrating an example computer system with aspects of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Aspects of the subject disclosure provide for gesture-based control of electronic devices. As but a few examples, gesture-based control can include pinching and turning a virtual dial (e.g., a virtual volume knob) or pinching and sliding a virtual slider (e.g., moving a virtual dimmer switch, or scrolling through a movie or song timeline).

In one or more implementations, the disclosed gesture-based control leverages multiple types of sensor data (e.g., electromyography (EMG) and inertial measurement unit (IMU) data), processed, in part, using multiple respective neural networks, to generate a gesture prediction. The gesture prediction may be determined along with a probability that the predicted gesture is being performed. Various additional processing features enhance the ability of the disclosed gesture detection operations to identify (e.g., using this multi-modal data) when to activate gesture control based on a gesture prediction. In one or more implementations, when a likelihood of a user's intent to perform a particular gesture reaches a threshold, gesture-based control can be activated. The disclosed gesture-based control operations can also include providing adaptive visual, auditory, and/or haptic feedback that indicates a current estimate of the likelihood of a user's intent to provide gesture-based input. The disclosed gesture-based control can also include a voice-activated or gesture-activated trigger that informs subsequent gesture detection for activation of gesture-based control.

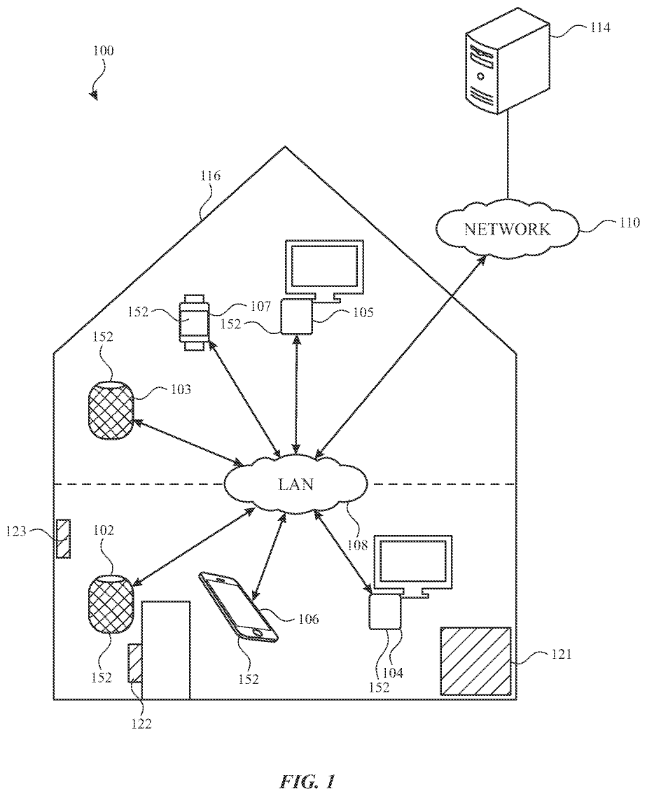

FIG. 1 illustrates an example network environment 100 that includes various devices in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes electronic devices 102, 103, 104, 105, 106 and 107 (hereinafter “the electronic devices 102-107”), a local area network (“LAN”) 108, a network 110, and one or more servers, such as server 114.

In one or more implementations, one, two, or more than two (e.g., all) of the electronic devices 102-107 may be associated with (e.g., registered to and/or signed into) a common account, such as an account (e.g., user account) with the server 114. As examples, the account may be an account of an individual user or a group account. As illustrated in FIG. 1, one or more of the electronic devices 102-107 may include one or more sensors 152 for sensing aspects of the environment around the device, such as the presence or location of other devices and/or for sensing gestures performed by a user of the device.

In one or more implementations, the electronic devices 102-107 may form part of a connected home environment 116, and the LAN 108 may communicatively (directly or indirectly) couple any two or more of the electronic devices 102-107 within the connected home environment 116. Moreover, the network 110 may communicatively (directly or indirectly) couple any two or more of the electronic devices 102-107 with the server 114, for example, in conjunction with the LAN 108. Electronic devices such two or more of the electronic devices 102-107 may communicate directly over a secure direct connection in some scenarios, such as when electronic device 106 is in proximity to electronic device 105. Although the electronic devices 102-107 are depicted in FIG. 1 as forming a part of a connected home environment in which all of the devices are connected to the LAN 108, one or more of the electronic devices 102-107 may not be a part of the connected home environment and/or may not be connected to the LAN 108 at one or more times.

In one or more implementations, the LAN 108 may include one or more different network devices/network medium and/or may utilize one or more different wireless and/or wired network technologies, such as Ethernet, optical, Wi-Fi, Bluetooth, Zigbee, Powerline over Ethernet, coaxial, Ethernet, Z-Wave, cellular, or generally any wireless and/or wired network technology that may communicatively couple two or more devices.

In one or more implementations, the network 110 may be an interconnected network of devices that may include, and/or may be communicatively coupled to, the Internet. For explanatory purposes, the network environment 100 is illustrated in FIG. 1 as including electronic devices 102-107, and the server 114; however, the network environment 100 may include any number of electronic devices and any number of servers.

One or more of the electronic devices 102-107 may be, for example, a portable computing device such as a laptop computer, a smartphone, a smart speaker, a peripheral device (e.g., a digital camera, headphones), a digital media player, a tablet device, a wearable device such as a smartwatch or a band device, a connected home device, such as a wireless camera, a router and/or wireless access point, a wireless access device, a smart thermostat, smart light bulbs, home security devices (e.g., motion sensors, door/window sensors, etc.), smart outlets, smart switches, and the like, or any other appropriate device that includes and/or is communicatively coupled to, for example, one or more wired or wireless interfaces, such as WLAN radios, cellular radios, Bluetooth radios, Zigbee radios, near field communication (NFC) radios, and/or other wireless radios.

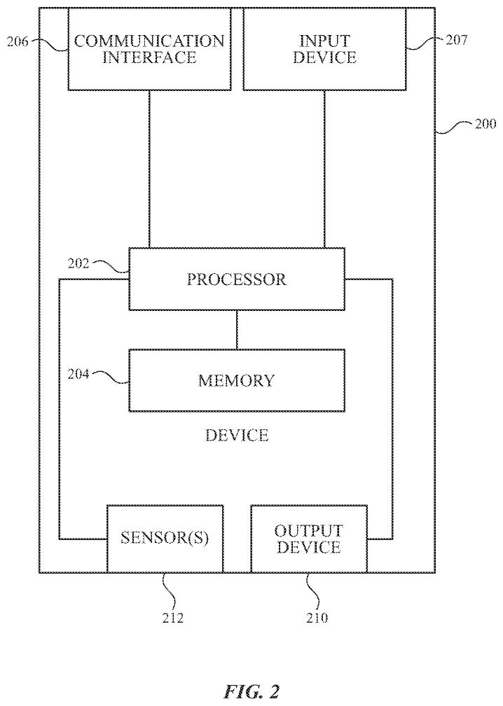

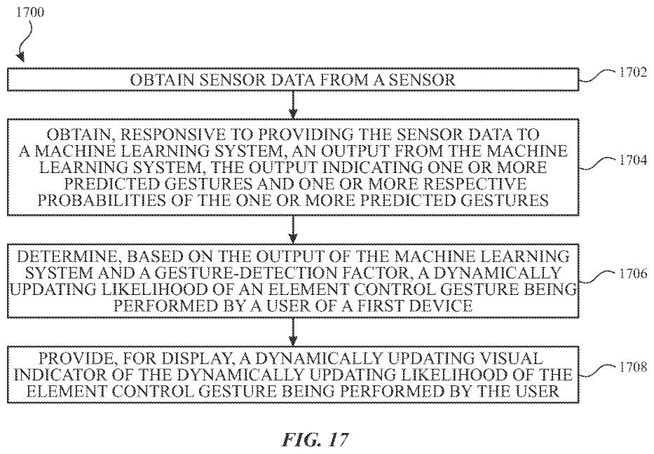

By way of example, in FIG. 1 each of the electronic devices 102-103 is depicted as a smart speaker, the electronic device 106 is depicted as a smartphone, the electronic device 107 is depicted as a smartwatch, and each of the electronic devices 104 and 105 is depicted as a digital media player (e.g., configured to receive digital data such as music and/or video and stream it to a display device such as a television or other video display). In one or more implementations, one or more of the electronic devices 104 and 105 may be integrated into or separate from a corresponding display device. One or more of the electronic devices 102-107 may be, and/or may include all or part of, the device discussed below with respect to FIG. 2, and/or the electronic system discussed below with respect to FIG. 17.

In one or more implementations, one or more of the electronic devices 102-107 may include one or more machine learning models that provides an output of data corresponding to a prediction or transformation or some other type of machine learning output. As shown in FIG. 1, the network environment 100 may also include one or more controllable devices including the electronic devices 102-107 and additional devices such as an appliance 121, a light source 123 (e.g., a lamp, a floor light, a ceiling light, or any other lighting device), and/or an IoT device 122 (e.g., a wireless camera, a router and/or wireless access point, a wireless access device, a smart thermostat, smart light bulbs, home security devices (e.g., motion sensors, door/window sensors, etc.), smart outlets, smart switches, and the like, or any other appropriate device, appliance, machine, or object that includes and/or is communicatively coupled to, for example, one or more wired or wireless interfaces, such as WLAN radios, cellular radios, Bluetooth radios, Zigbee radios, near field communication (NFC) radios, and/or other wireless radios). In the example of FIG. 1, one or more of the electronic devices 102-107, such as the electronic device 106 and/or the electronic device 107, may be configured as gesture-control devices that are capable recognizing gestures for controlling that device and/or one or more other devices, such as for gesture-based control of one or more of the electronic device 102, the electronic device 103, the electronic device 104, the electronic device 105, the appliance 121, the light source 123, and/or the IoT device 122.

In one or more implementations, the server 114 may be configured to perform operations in association with user accounts such as: storing data (e.g., user settings/preferences, files such as documents and/or photos, etc.) with respect to user accounts, sharing and/or sending data with other users with respect to user accounts, backing up device data with respect to user accounts, and/or associating devices and/or groups of devices with user accounts.

One or more of the servers such as the server 114 may be, and/or may include all or part of the device discussed below with respect to FIG. 2, and/or the electronic system discussed below with respect to FIG. 17. For explanatory purposes, a single server 114 is shown and discussed herein. However, one or more servers may be provided, and each different operation may be performed by the same or different servers.

FIG. 2 illustrates an example device that may implement a system for gesture-based control of that device and/or of other devices and/or systems in accordance with one or more implementations. For example, the device 200 of FIG. 2 can correspond to the electronic device 106 or the electronic device 107 of FIG. 1. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The device 200 may include a processor 202, a memory 204, a communication interface 206, an input device 207, an output device 210, and one or more sensors 212. The processor 202 may include suitable logic, circuitry, and/or code that enable processing data and/or controlling operations of the device 200. In this regard, the processor 202 may be enabled to provide control signals to various other components of the device 200. The processor 202 may also control transfers of data between various portions of the device 200. Additionally, the processor 202 may enable implementation of an operating system or otherwise execute code to manage operations of the device 200.

The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage.

In one or more implementations, the memory 204 may store one or more feature extraction models, one or more gesture prediction models, one or more gesture detectors, one or more (e.g., virtual) controllers (e.g., sets of gestures and corresponding actions to be performed by the device 200 or another electronic devices when specific gestures are detected), voice assistant applications, and/or other information (e.g., locations, identifiers, location information, etc.) associated with one or more other devices, using data stored locally in memory 204. Moreover, the input device 207 may include suitable logic, circuitry, and/or code for capturing input, such as audio input, remote control input, touchscreen input, keyboard input, etc. The output device 210 may include suitable logic, circuitry, and/or code for generating output, such as audio output, display output, light output, and/or haptic and/or other tactile output (e.g., vibrations, taps, etc.).

The sensors 212 may include one or more ultra-wide band (UWB) sensors, one or more inertial measurement unit (IMU) sensors (e.g., one or more accelerometers, one or more gyroscopes, one or more compasses and/or magnetometers, etc.), one or more image sensors (e.g., coupled with and/or including an computer-vision engine), one or more electromyography (EMG) sensors, optical sensors, light sensors, image sensors, pressure sensors, strain gauges, lidar sensors, proximity sensors, ultrasound sensors, radio-frequency (RF) sensors, platinum optical intensity sensors, and/or other sensors for sensing aspects of the environment around and/or in contact with the device 200 (e.g., including objects, devices, and/or user movements and/or gestures in the environment). The sensors 212 may also include motion sensors, such as inertial measurement unit (IMU) sensors (e.g., one or more accelerometers, one or more gyroscopes, and/or one or more magnetometers) that sense the motion of the device 200 itself.

The communication interface 206 may include suitable logic, circuitry, and/or code that enables wired or wireless communication, such as between any of the electronic devices 102-107 and/or the server 114 over the network 110 (e.g., in conjunction with the LAN 108). The communication interface 206 may include, for example, one or more of a Bluetooth communication interface, a cellular interface, an NFC interface, a Zigbee communication interface, a WLAN communication interface, a USB communication interface, or generally any communication interface.

In one or more implementations, one or more of the processor 202, the memory 204, the communication interface 206, the input device 207, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

In one or more implementations, memory 204 may store a machine learning system that includes one or more machine learning models that may receive, as inputs, outputs from one or more of the sensor(s) 212. The machine learning models may have been trained based on outputs from various sensors corresponding to the sensors(s) 212, in order to detect and/or predict a user gesture. When the device 200 detects a user gesture using the sensor(s) 212 and the machine learning models, the device 200 may perform a particular action (e.g., raising or lowering a volume of audio output being generated by the device 200, scrolling through video or audio content at the device 200, other actions at the device 200, and/or generating a control signal corresponding to a selected device and/or a selected gesture-control element for the selected device, and transmitting the control signal to the selected device). In one or more implementations, the machine learning models may be trained based on a local sensor data from the sensor(s) 212 at the device 200, and/or based on a general population of devices and/or users. In this manner, the machine learning models can be re-used across multiple different users even without a priori knowledge of any particular characteristics of the individual users in one or more implementations. In one or more implementations, a model trained on a general population of users can later be tuned or personalized for a specific user of a device such as the device 200.

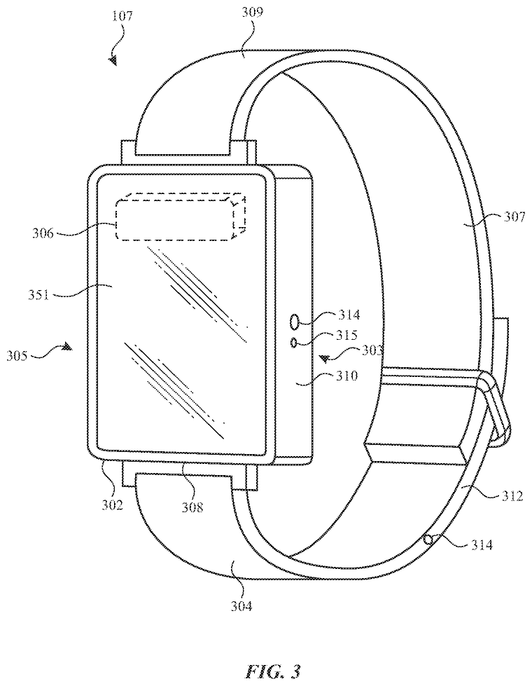

In one or more implementations, the device 200 may include various sensors at various locations for determining proximity to one or more devices for gesture control, for determining relative or absolute locations of the device(s) for gesture control, and/or for detecting user gestures (e.g., by providing sensor data from the sensor(s) to machine learning a machine learning system). FIG. 3 illustrates an example in which the device 200 is implemented in the form of the electronic device 107 of FIG. 1, in one exemplary arrangement that can be used for gesture-based control of one or more electronic devices.

In the example of FIG. 3, electronic device 107 has been implemented in the form of a smartwatch. In this implementation, the electronic device 107 may be a standalone device that performs computing functions such as cellular telephone communications, WiFi communications, digital display functions, fitness tracking functions, or other computing functions, and/or may cooperate with one or more external devices or components such as a smartphone, a gaming system, or other computing system that is wirelessly paired or otherwise wirelessly coupled to the electronic device. For example, hand gestures performed by the hand on which the device is worn (e.g., on the attached wrist) can be used as input commands for controlling the electronic device 107 itself and/or for operating one or more other devices, such as any or all of the electronic devices 102-106, the appliance 121, the light source 123, and/or the IoT device 122 of FIG. 1.

As shown in FIG. 3, the electronic device 107 may include a housing 302 and a band 304 that is attached to housing 302. In the example of FIG. 3, housing 302 forms a watch case having an outer surface 305 formed by a display 351. In this example, circuitry 306 (e.g., processor 202, memory 204, sensors 212, communication interface 206 and/or other circuitry of the device 200 of FIGS. 2A and 2B) is disposed within the housing 302.

Housing 302 and band 304 may be attached together at interface 308. Interface 308 may be a purely mechanical interface or may include an electrical connector interface between circuitry within band 304 and circuitry 306 within housing 302 in various implementations. Processing circuitry such as the processor 202 of circuitry 306 may be communicatively coupled to one or more of sensors 212 that are mounted in the housing 302 and/or one or more of sensors 212 that are mounted in the band 304 (e.g., via interface 308).

In the example of FIG. 3, the housing 302 of the electronic device 107 includes sidewall 310 that faces the user's hand when the electronic device 107 is worn. In one or more implementations, the band 304 may also include a sidewall 312. Housing 302 also includes a wrist-interface surface 303 (indicated but not visible in FIG. 3) and an opposing outer surface 305 (e.g., formed by the display 351). Sidewall 310 extends between wrist-interface surface 303 and outer surface 305. In this example, band 304 includes a wrist-interface surface 307 and an opposing outer surface 309, and sidewall 312 extends between wrist-interface surface 307 and outer surface 309.

In one or more implementations, one or more of the sensors 212 may be mounted on or to the sidewall 310 of housing 302. In the example of FIG. 3, an ultra-wide band (UWB) sensor 314 is provided at or near the sidewall 310. In the example of FIG. 3, the electronic device 107 also includes a camera 315 mounted in or to the sidewall. In the example of FIG. 3, the electronic device 107 also include a UWB sensor 314 at or near the sidewall 312 of the band 304. However, this is merely illustrative. In various implementations, a UWB sensor 314 may be provided on or within the housing 302 without any cameras on or within the housing 302, and/or without any cameras or UWB sensors in the band 304.

Although various examples, including the example of FIG. 3, are described herein in which a UWB sensor is used to determine a direction in which a device is pointing and/or another device at which the device is aimed or pointed, it is appreciated that other sensors and/or sensing technologies may be used for determining a pointing direction of a device and/or to recognize another device at which the device is aimed or pointed. As examples, other sensors and/or sensing technologies may include a computer-vision engine that receives images of the device environment from an image sensor, and/or a BLE sensor.

Although not visible in FIG. 3, one or more additional sensors 212 may also be provided on wrist-interface surface 303 of housing 302, and communicatively coupled with the circuitry 306. The additional sensors 212 that may be provided on wrist-interface surface 303 may include a photoplethysmography (PPG) sensor configured to detect blood volume changes in microvascular bed of tissue of a user (e.g., where the user is wearing the electronic device 107 on his/her body, such as his/her wrist). The PPG sensor may include one or more light-emitting diodes (LEDs) which emit light and a photodiode/photodetector (PD) which detects reflected light (e.g., light reflected from the wrist tissue). The additional sensors 212 that may be provided on wrist-interface surface 303 may additionally or alternatively correspond to one or more of: an electrocardiogram (ECG) sensor, an electromyography (EMG) sensor, a mechanomyogram (MMG) sensor, a galvanic skin response (GSR) sensor, and/or other suitable sensor(s) configured to measure biosignals. In one or more implementations, the electronic device 107 may additionally or alternatively include non-biosignal sensor(s) such as one or more sensors for detecting device motion, sound, light, wind and/or other environmental conditions. For example, the non-biosignal sensor(s) may include one or more of: an accelerometer for detecting device acceleration, rotation, and/or orientation, one or more gyroscopes for detecting device rotation and/or orientation, an audio sensor (e.g., microphone) for detecting sound, an optical sensor for detecting light, and/or other suitable sensor(s) configured to output signals indicating device state and/or environmental conditions, and may be included in the circuitry 306.

It is appreciated that, although an example implementation of the device 200 in a smartwatch is described herein in connection with various examples, these examples are merely illustrative, and the device 200 may be implemented in other form factors and/or device types, such as in a smartphone, a tablet device, a laptop computer, another wearable electronic device (e.g., a head worn device) or any other suitable electronic device that includes, for example machine learning system for detecting gestures.

In general, sensors for detecting gestures may be any sensors that generate input signals (e.g., to a machine learning system, such as to machine learning models such as feature extraction models) responsive to physical movements and/or positioning of a user's hand, wrist, arm, and/or any other suitable portion of a user's body. For example, to generate the input signals, the sensors may detect movement and/or positioning of external and/or internal structures of the user's hand, wrist, and/or arm during the physical movements of the user's hand, wrist, and/or arm. For example, light reflected from or generated by the skin of the user can be detected by one or more cameras or other optical or infrared sensors.

As another example, electrical signals generated by the muscles, tendons or bones of the wearer can be detected (e.g., by electromyography sensors). As another example, ultrasonic signals generated by an electronic device and reflected from the muscles, tendons or bones of the user can be detected by an ultrasonic sensor. In general, EMG sensors, ultrasonic sensors, cameras, IMU sensors (e.g., an accelerometer, a gyroscope and/or a magnetometer), and/or other sensors may generate signals that can be provided to machine-learning models of a gesture detection system to identify a position or a motion of the wearer's hand, wrist, arm, and/or other portion of the user's body, and thereby detect user gestures.

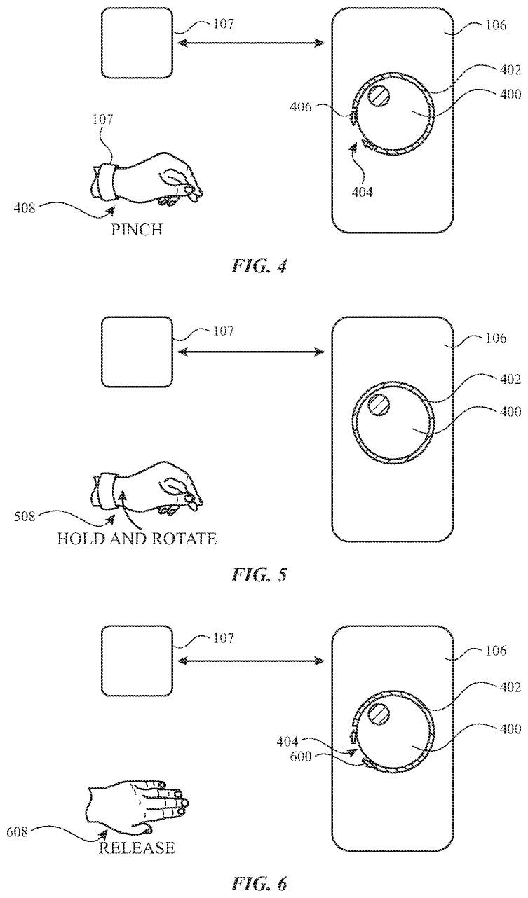

FIG. 4 illustrates an example use case in which the electronic device 107 is operating a gesture control system (e.g., comprising a machine learning system having one or more machine learning models) to determine whether a user (e.g., wearer) of the electronic device 107 is performing a gesture intended for gesture control. In the example of FIG. 4, the user of the electronic device 107 is in the process of forming a gesture 408 with their hand, for control of an element at the electronic device 106. In this example, the element at the electronic device 106 is a virtual dial 400 that is displayed on a display of the electronic device 106. As examples, the virtual dial 400 may be rotated to increase or decrease the volume of audio output being generated by a speaker of the electronic device 107, to increase or decrease the volume of audio output being generated by a speaker of the electronic device 106, to increase or decrease the volume of audio output being generated by a speaker to which the electronic device 106 is transmitting audio content, or to increase or decrease a brightness of a light source (e.g., a lamp, a light bulb, etc.) having a smart controller to which the electronic device 106 is connected.

In the example of FIG. 4, a visual indicator 402 is displayed by the electronic device 106, extending partially around the perimeter of the virtual dial 400, with a gap 404 between ends of the visual indicator. In this example, the electronic device 107 provides sensor data (e.g., EMG data, IMU data, etc.) to a machine learning system at the electronic device 107 that determines a likelihood that the user of the electronic device 107 is performing the gesture 408 (e.g., a pinch-and-hold gesture in this example).

In this example, the fraction of the perimeter of the virtual dial 400 that is surrounded by the visual indicator 402 may scale with the determined likelihood that the user is performing the gesture 408 (e.g., is intentionally performing the gesture 408). That is, in one or more implementations, the visual indicator 402 may be a dynamically updating visual indicator of a dynamically updating likelihood of an element control gesture (e.g., the gesture 408) being performed by the user. For example, the electronic device 107 may dynamically scale an overall size (e.g., a circumferential length in this example) of the visual indicator with the dynamically updating likelihood.

In the example of FIG. 4, the arrows 406 (which are included in the figure for illustrative purposes, but may not be displayed by the electronic device 106 during operation) indicate that the visual indicator 402 is increasing in size around the perimeter of the virtual dial 400, to close the gap 404 and indicate an increasing likelihood that the user is performing the gesture 408 for gesture-based control of the virtual dial. The visual indicator 402 can be used, for example, by the user of the electronic device 107, to change the position/orientation of their hand if the gesture 408 is not intended to be detected by the electronic device, or to continue to hold the gesture 408 if detection of the gesture 408 is intended.

FIG. 5 illustrates an example use case in which the user of the electronic device 107 continues to hold the gesture 408 until the likelihood of the gesture determined by the electronic device 107 reaches a threshold for activation of gesture control. In one or more implementations described hereinafter in further detail, the overall size, and/or component sizes of components of, a visual indicator can be scaled with the likelihood. In one or more implementations described hereinafter in further detail, component sizes can also fluctuate, with a variation that scales inversely with the likelihood.

In the use case of FIG. 5, the visual indicator 402 has increased in size to a maximum overall size, such that the visual indicator 402 fully surrounds the virtual dial 400. In this way, the visual indicator may indicate that the threshold for the likelihood has been met and that gesture control of the virtual dial 400 has been activated. As shown in FIG. 5, the user may then perform a rotation gesture 508 while holding the pinch-and-hold gesture (e.g., a pinch-and-rotate gesture or pinch-and-hold-and-rotate gesture), to cause the virtual dial to rotate (and cause the resulting action to be performed by the electronic device 107 and/or the electronic device 106). In one or more implementations, in addition to increasing the overall size of the visual indicator 402 to its maximum overall size, one or more other types of visual feedback that gesture control has been activated may be provided, such as changing a color of the visual indicator and/or displaying an animation of, or associated with, the visual indicator. The one or more other types of visual feedback and/or auditory and/or haptic feedback can be provided when it is determined that the likelihood of the gesture 408 has reached the threshold. In one or more implementations, the threshold may be a gesture-detection sensitivity threshold, and may be adjustable by the user of the electronic device 107.

FIG. 6 illustrates a use case in which the user of the electronic device 107 has released the pinch-and-hold gesture (e.g., and has their hand in, for example, a resting state or release gesture 608). As shown by FIG. 6, when the gesture 408 of FIG. 4 or the rotation gesture 508 of FIG. 5 is released, the electronic device 107 may reduce the overall size of visual indicator 402 (e.g., as indicated by arrows 600, which themselves may not be displayed by the electronic device 106). For example, the overall size of the visual indicator 402 may be reduced, scaling with a reducing likelihood (determined by the electronic device 107) of the gesture being performed. In the example of FIG. 6, the fraction of the perimeter of the virtual dial 400 that is surrounded by the visual indicator 402 is decreasing with the decreasing likelihood.

Although the example of FIGS. 4-6 depict the virtual dial 400 and the visual indicator 402 displayed by the electronic device 106, the virtual dial 400 and the visual indicator 402 can be displayed by the electronic device 107 itself or by any other electronic device to which the electronic device 107 is communicatively coupled (e.g., a smart television, a wearable headset, etc.). Although various examples described herein discuss a likelihood of a gesture being determined by the electronic device 107, the processing operations for determining the likelihood of a gesture may be performed in part, or entirely, by one or more other electronic devices (e.g., by receiving sensor data or other data based on the sensor data from the electronic device 107 and operating a gesture control system at that device).

In the example of FIGS. 4-6, the visual indicator 402 is in the form of a circular dial. However, this is merely illustrative and a visual indicator having a size that scales with a likelihood of a gesture may be a linear indicator (e.g., for a linear control element such as a virtual slider (e.g., controllable using a pinch-and-pan gesture performed after a pinch-and-hold element control gesture has been detected), or a visual indicator having any other form factor for any other virtual control element, such as a virtual knob, a virtual switch or any other virtual element that can be controlled by a gesture (e.g., in the manner that a corresponding physical element could be controlled by a physical motion of a user's hand or other body part).

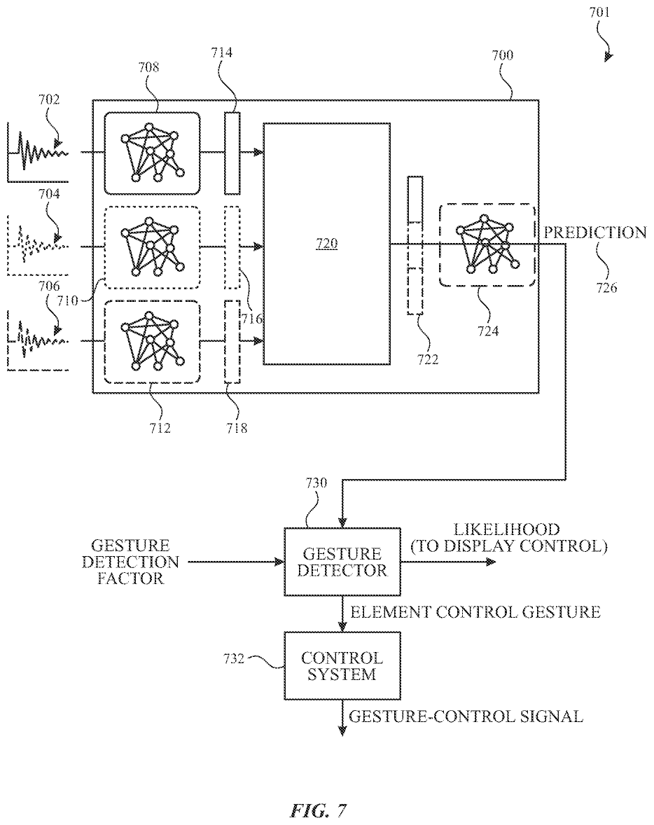

FIG. 7 illustrates schematic diagram of a gesture control performing a process for gesture control, in accordance with aspects of the disclosure. As shown in FIG. 7, sensor data from one or more sensors may be provided to gesture control system 701 (e.g., operating at the electronic device 107, such as by the processor 202 from the memory 204 of FIG. 2). For example, the sensor data may include sensor data 702 (e.g., accelerometer data from one or more accelerometers), sensor data 704 (e.g., gyroscope data from one or more gyroscopes), and/or sensor data 706 from one or more physiological sensors (e.g., EMG data from an EMG sensor). As shown, the gesture control system 701 may include a machine learning system 700, a gesture detector 730, and/or a control system 732. In one or more implementations, the machine learning system 700, the gesture detector 730, and the control system 732 may be implemented at the same device, which may be the device in which the sensors that generate the sensor data are disposed, or may be a different device from the device in which the sensors that generate the sensor data are disposed. In one or more other implementations, the machine learning system 700, the gesture detector 730, and the control system 732 across multiple different devices, which may be include or be separate from the device in which the sensors that generate the sensor data are disposed. For example, the machine learning system 700 and the gesture detector 730 may be implemented at one device and the control system 732 may be implemented at a different device.

In one or more implementations, one or more of the sensor data 702, the sensor data 704, and the sensor data 706 may have characteristics (e.g., noise characteristics) that significantly differ from the characteristics of others of the sensor data 702, the sensor data 704, and the sensor data 706. For example, EMG data (e.g., sensor data 706) is susceptible to various sources of noise arising from nearby electrical devices, or bad skin-to-electrode contact. Therefore, EMG data can be significantly noisier than accelerometer data (e.g., sensor data 702) or gyroscope data (e.g., sensor data 704). This can be problematic for training a machine learning model to detect a gesture based on these multiple different types of data with differing characteristics.

The system of FIG. 7 addresses this difficultly with multi-modal sensor data by, for example, providing the sensor data from each sensor to a respective machine learning model trained on sensor data of the same type. Intermediate processing operations 720 may also be performed to enhance the effectiveness of using multi-modal sensor data for gesture control. In the example of FIG. 7, sensor data 702 is provided as an input to a machine learning model 708, sensor data 704 is provided as an input to a machine learning model 710, and sensor data 706 is provided as an input to a machine learning model 712. In one or more implementations, machine learning model 708, machine learning model 710, and machine learning model 712 may be implemented as trained convolutional neural networks, or other types of neural networks.

For example, the machine learning model 708 may be a feature extractor trained to extract features of sensor data of the same type as sensor data 702, the machine learning model 710 may be a feature extractor trained to extract features of sensor data of the same type as sensor data 704, and the machine learning model 712 may be a feature extractor trained to extract features of sensor data of the same type as sensor data 706. As shown, machine learning model 708 may output a feature vector 714 containing features extracted from sensor data 702, machine learning model 710 may output a feature vector 716 containing features extracted from sensor data 704, and machine learning model 708 may output a feature vector 718 containing features extracted from sensor data 706. In this example, three types of sensor data are provided to three feature extractors, however, more or less than three types of sensor data may be used in conjunction with more or less than three corresponding feature extractors in other implementations.

As shown in FIG. 7, the feature vector 714, the feature vector 716, and the feature vector 718 may be processed in the intermediate processing operations 720 of the machine learning system 700 to combine aspects of the feature vector 714, the feature vector 716, and the feature vector 718 to generate a combined input vector 722 for input to a gesture prediction model 724.

In order to generate the combined input vector 722 for the gesture prediction model 724, the intermediate processing operations 720 may perform modality dropout operations, average pooling operations, modality fusion operations and/or other intermediate processing operations. For example, the modality dropout operations may periodically and temporarily replace one, some, or all of the feature vector 714, the feature vector 716, or the feature vector 718 with replacement data (e.g., zeros) while leaving the others of the feature vector 714, the feature vector 716, or the feature vector 718 unchanged. In this way, the modality dropout operations can prevent the gesture prediction model from learning to ignore sensor data from one or more of the sensors (e.g., by learning to ignore, for example, high noise data when other sensor data is low noise data). Modality dropout operations can be performed during training of the gesture prediction model 724, and/or during prediction operations with the gesture prediction model 724. In one or more implementations, the modality dropout operations can improve the ability of the machine learning system 700 to generate reliable and accurate gesture predictions using multi-mode sensor data. In one or more implementations, the average pooling operations may include determining one or more averages (or other mathematical combinations, such as medians) for one or more portions of the feature vector 714, the feature vector 716, and/or the feature vector 718 (e.g., to downsample one or more of the feature vector 714, the feature vector 716, and/or the feature vector 718 to a common size with the others of the feature vector 714, the feature vector 716, and/or the feature vector 718, for combination by the modality fusion operations). In one or more implementations, the modality fusion operations may include combining (e.g., concatenating) the features vectors processed by the modality dropout operations and the average pooling operations to form the combined input vector 722.

The gesture prediction model 724 may be a machine learning model that has been trained to predict a gesture that is about to be performed or that is being performed by a user, based on a combined input vector 722 that is derived from multi-modal sensor data. In one or more implementations, the machine learning system 700 of the gesture control system 701 (e.g., including the machine learning model 708, the machine learning model 710, the machine learning model 712, and the gesture prediction model 724) may be trained on sensor data obtained by the device in which the machine learning system 700 is implemented and from the user of that device, and/or sensor data obtained from multiple (e.g., hundreds, thousands, millions) of devices from multiple (e.g., hundreds, thousands, millions) of anonymized users, obtained with the explicit permission of the users. In one or more implementations, the gesture prediction model 724 may output a prediction 726. In one or more implementations, the prediction 726 may include one or more predicted gestures (e.g., of one or multiple gestures that the model has been trained to detect), and may also output a probability that the predicted gesture has been detected. In one or more implementations, the gesture prediction model may output multiple predicted gestures with multiple corresponding probabilities. In one or more implementations, the machine learning system 700 can generate a new prediction 726 based on new sensor data periodically (e.g., once per second, ten times per second, hundreds of times per second, once per millisecond, or with any other suitable periodic rate).

As shown in FIG. 7, the prediction 726 (e.g., one or more predicted gestures and/or one or more corresponding probabilities) from the gesture prediction model 724 may be provided to a gesture detector 730 (e.g., at the electronic device 107, executed by the processor 202 from the memory 204). In one or more implementations, the gesture detector 730 may determine, a likelihood of a particular gesture (e.g., an element control gesture) being performed by the user based on the predicted gesture and the corresponding probability from the gesture prediction model 724, and based on a gesture detection factor.

For example, the gesture detector 730 may periodically generate a dynamically updating likelihood of an element control gesture (e.g., a pinch-and-hold gesture), such as by generating a likelihood for each prediction 726 or for aggregated sets of predictions 726 (e.g., in implementations in which temporal smoothing is applied). For example, when an element control gesture is the highest probability gesture from the gesture prediction model 724, the gesture detector 730 may increase the likelihood of the element control gesture based on the probability of that gesture from the gesture prediction model 724, and based on the gesture detection factor. For example, the gesture detection factor may be a gesture-detection sensitivity threshold. In one or more implementations, the gesture-detection sensitivity threshold may be a user-controllable threshold that the user can change to set the sensitivity of activating gesture control to the user's desired level. In one or more implementations, the gesture detector 730 may increase the likelihood of the element control gesture based on the probability of that gesture from the gesture prediction model 724, and based on the gesture detection factor by increasing the likelihood by an amount corresponding to a higher of the probability of the element control gesture and a fraction (e.g., half) of the gesture-detection sensitivity threshold.

In a use case in which the element control gesture is not the gesture with the highest probability from the gesture prediction model 724 (e.g., the gesture prediction model 724 has output the element control gesture with a probability that is lower than the probability of another gesture predicted in the output of the gesture prediction model 724), the gesture detector 730 may decrease the likelihood of the element control gesture by an amount corresponding to a higher of the probability of whichever gesture has the highest probability from the gesture prediction model 724 and a fraction (e.g., half) of the gesture-detection sensitivity threshold. In this way, the likelihood can be dynamically updated up or down based on the output of the gesture prediction model 724 and the gesture detection factor (e.g., the gesture-detection sensitivity threshold).

As each instance of this dynamically updating likelihood is generated, the likelihood (e.g., or an aggregated likelihood based on several recent instances of the dynamically updating likelihood, in implementations in which temporal smoothing is used) may be compared to the gesture-detection sensitivity threshold. When the likelihood is greater than or equal to the gesture-detection sensitivity threshold, the gesture detector 730 may determine that the gesture has been detected and may provide an indication of the detected element control gesture to a control system 732. When the likelihood is less than the gesture-detection sensitivity threshold, the gesture detector 730 may determine that the gesture has not been detected and may not provide an indication of the detected element control gesture to a control system 732. In one or more implementations, providing the indication of the detected element control gesture may activate gesture-based control of an element at the electronic device 107 or another electronic device, such as the electronic device 106. In these examples, the gesture-detection sensitivity threshold is used in the adjusting (e.g., increasing or decreasing) of the likelihood, and as the threshold to which the likelihood is compared. In one or more other implementations, the gesture control factor may include a likelihood adjustment factor is used in the adjusting (e.g., increasing or decreasing) of the likelihood and that is separate from the gesture-detection sensitivity threshold to which the (e.g., adjusted) likelihood is compared for gesture control activation.

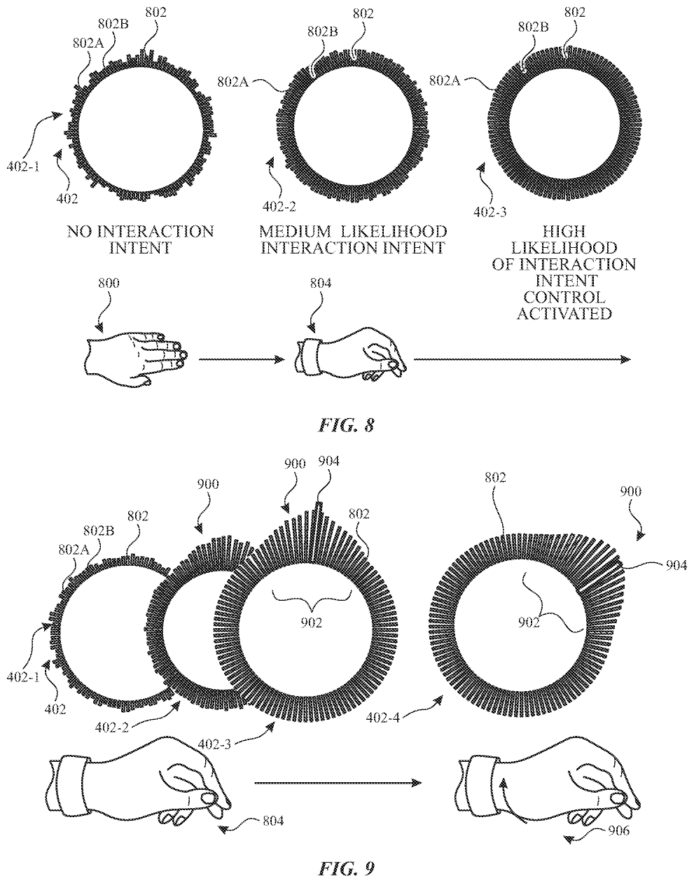

Throughout the dynamic updating of the likelihood by the gesture detector 730 (e.g., based on output of the gesture detection model 724 and based on the likelihood adjustment factor and/or the gesture-detection sensitivity threshold), the dynamically updating likelihood may be provided to a display controller. For example, the display controller (e.g., an application-level or system-level process with the capability of controlling display content for display at the electronic device 107 or the electronic device 106) may generate and/or update a visual indicator, in accordance with the likelihood (e.g., as described, for example, above in connection with FIGS. 4-6 and/or hereinafter in connection with FIGS. 8 and 9). As the likelihood increases and decreases (and while the likelihood remains below the gesture-detection sensitivity threshold), the display controller may increase and decrease the overall size of the visual indicator, and/or may decrease and increase variability (variance) of one or more component sizes of one or more components of the visual indicator. When the element control gesture is provided to the control system 732 (e.g., responsive to the likelihood of the element control gesture reaching the threshold), this may coincide with the display controller increasing the visual indicator to its maximum size, changing its color, and/or animating the visual indicator to indicate activation of gesture control.

In various implementations, the control system 732 and/or the display controller may be implemented as, or as part of, a system-level process at an electronic device or as, or as part of an application (e.g., a media player application that controls playback of audio and/or video content, or a connected home application that controls smart appliances, light sources, or the like). In various implementations, the display controller may be implemented at the electronic device with the gesture prediction model 724 and the gesture detector 730, or may be implemented at a different device (e.g., electronic device 106). In one or more implementations, the control system 732 and the display controller may be implemented separately or as part of a common system or application process.

Once the element control gesture is detected and the gesture-based control is activated, gesture control system 701 of FIG. 7 may continue to operate, such as to detect an ongoing hold of the element control gesture and/or a motion and/or rotation of the element control gesture. The gesture control system 701 may provide an indication of the motion and/or rotation to the control system 732 for performing a device control operation, such as for control of the element (e.g., to rotate the virtual dial or slide the virtual slider and/or to modifying an underlying device function corresponding to the virtual dial or virtual slider).

As discussed herein in connection with, for example, FIGS. 4-6, in one or more implementations, the visual indicator of the likelihood may be displayed, in part, by dynamically scaling an overall size of the visual indicator with the dynamically updating likelihood. In the example of FIGS. 4-6, the visual indicator 402 is a smoothly contiguous indicator. However, this is merely illustrative.

FIG. 8 illustrates how, in one or more implementations, the visual indicator 402 may include multiple distinct visual indicator components 802, having a multiple respective component sizes. In one or more implementations, the visual indicator 402 may be updated (e.g., in addition to, or alternatively to updating the transverse (e.g., circumferential) extent of the visual indicator) by dynamically varying the multiple respective component sizes by an amount that scales inversely with the dynamically updating likelihood. For example, in FIG. 8, a visual indicator component 802A of the visual indicator components 802 has a first size (e.g., a first length, such as a radial length along a radius from a center of the visual indicator 402) and a visual indicator component 802B of the visual indicator components 802 has a second size (e.g., a second length, such as a second radial length along a different the radius from the center of the visual indicator 402). In this example, the circumferential extent of the visual indicator 402 traverses a full circle, and the likelihood of the element control gesture is indicated by an overall (e.g., average or median) length of the visual indicator components 802, and by an amount of the variation in the individual component sizes of the visual indicator components 802.

In the example of FIG. 8, as the likelihood of the element control gesture increases, according to the output of the gesture detector 730, the overall (e.g., average or median) length of the visual indicator components 802 increases from state 402-1 (e.g., in which a resting or release gesture 800 is being performed or no gesture is being performed), to state 402-2 (in which the likelihood of the element control gesture 804 is increasing), and to state 402-3 (e.g., in which the element control gesture 802 has been detected), and the amount of the variation (e.g., variance) in the individual component sizes of the visual indicator components 802 decreases from state 402-1, to state 402-2, and to state 402-3. As shown, at state 402-3 (e.g., when the likelihood has reached the gesture-detection sensitivity threshold), the lengths of the visual indicator components 802 may have the same, maximum, component size (e.g., equal to a maximum overall (e.g., average or median) component size), and may be free of size variance. In this way, the state 402-3 can indicate that gesture-based control has been activated.

In the example of FIG. 8, the visual indicator 402 does not have a visual indicator of orientation. In another example, FIG. 9 illustrates how the visual indicator may be provided with an orientation indicator 900 that indicates an orientation of the element control gesture 804. As shown, as the likelihood of the element control gesture increases from state 402-1, to state 402-2, and to state 402-3, the orientation indicator 900 can begin to appear at a location on the visual indicator 402. For example, a subset of the multiple respective component sizes of a respective subset 902 of the plurality of distinct visual indicator components 802 can be set to a first maximum overall component size that is larger than a second maximum component size (e.g., the maximum overall component size of state 402-3 of FIG. 8) of a remainder of the plurality of respective component sizes. In this way, the orientation indicator 900 can appear to protrude from the visual indicator 402 at a location that corresponds to an orientation of the element control gesture.

FIG. 9 also shows how a rotation gesture 906 (e.g., a pinch-and-rotate or a pinch-and-hold-and-rotate gesture), performed after the element control gesture 804 (e.g., the pinch-and-hold gesture) has been detected and gesture-based control has been activated, can cause the location of the orientation indicator to move (e.g., to a state 402-4). In the example of FIG. 9, the orientation indicator 900 on the visual indicator 402 rotates to a new angular position. However, this is merely illustrative, and a protrusion on a linear visual indicator can alternatively be provided that translates along the linear visual indicator according to a translational gesture (e.g., a pinch-and-pan gesture or pinch-and-hold-and-pan gesture performed after a pinch-and-hold or other element control gesture has been detected) in one or more other implementations. In one or more implementations, the electronic device 107 and/or the electronic device 106 (e.g., the control system 732) may effect the gesture-based control of the element according to the changing orientation that is displayed by the orientation indicator 900 (e.g., by performing device control operations, such as increasing or decreasing an audio volume, increasing or decreasing the brightness of a light source, or otherwise operating any other smart device that can be controlled by a virtual dial).

As shown in FIG. 9, visual indicator 402 can also be provided with an indicator 904 of a current setting of the element (e.g., a current volume or a current brightness). In one or more implementations, effecting the gesture-based control of the element may include dynamically updating a location of the indicator 904 by an amount that corresponds to an amount of change in the location of the orientation indicator 900.

In various implementations, updating the indicator 904 of the current setting (and controlling the element accordingly) may be a relative change that corresponds to a change in the element control gesture relative to the initial orientation the element control gesture was in at the time gesture control was activated, or may be a change that depends on a difference between the orientation of the element control gesture (e.g., as indicated by the orientation indicator 900) and the current setting (e.g., as indicated by the indicator 904). For example, in the example of FIG. 9, the location of the orientation indicator 900 and the location of the indicator 904 are the same in state 402-3, and the relative and absolute motion methods produce the same result of moving the indicator 904 by the same amount as the motion of the orientation indicator 900, as shown in state 402-4.

However, in a use case in which the location of the orientation indicator 900 and the location of the indicator 904 are initially different (e.g., when gesture control is activated), in a relative motion update, the indicator 904 (e.g., and the underlying element control) may be changed by an amount corresponding to an amount of the changing orientation of the element control gesture relative to an initial orientation of the element control gesture when the dynamically updating likelihood reaches the threshold likelihood. In this example, the change in location of the orientation indicator 900 and the change in the location of the indicator 904 may be by a same amount, but at different absolute locations.

In one or more other implementations, if the location of the orientation indicator 900 and the location of the indicator 904 are initially different (e.g., when gesture control is activated), the indicator 904 (e.g., and the underlying element control) may be changed based on the difference between the location of the indicator 904 and the orientation of the element control gesture. For example, for a difference between the initial locations of the orientation indicator 900 (e.g., and the underlying gesture) and the indicator 904 that is less than a first difference threshold, no change in the location of the indicator 904 maybe may be made. For a difference between the initial locations of the orientation indicator 900 and the indicator 904 that is greater than the first difference threshold and smaller than a second difference threshold, the location of the indicator 904 may be snapped to the location of the orientation indicator 900. For a difference between the initial locations of the orientation indicator 900 and the indicator 904 that is greater than the second difference threshold, the location of the indicator 904 may be smoothly moved toward the location of the orientation indicator 900 (e.g., with a speed that is scaled with the likelihood of the rotation gesture and/or the amount of the difference in the initial locations).

In various examples described herein, a visual indicator 402 is described. However, it is also appreciated that, in one or more implementations, auditory and/or haptic indicators of the likelihood of an element control gesture may also, or alternatively, be provided. As examples, a series of auditory and/or haptic taps may be provided with magnitudes, frequencies, and/or variances that scale with, or inversely to, the likelihood. In one example, haptic and/or auditory taps may be output to indicate active element control. In one or more other examples, haptic and/or auditory taps may be output with a frequency that increases at low and high likelihoods, and that decreases at likelihoods between the low and high likelihoods. In one or more other examples, haptic and/or auditory taps may be output with a frequency that decreases at low and high likelihoods, and that increases at likelihoods between the low and high likelihoods. In this way, the user can be guided by the frequency of the taps to commit to, or release, a potential element control gesture.

In one or more use cases, erroneous gesture control can occur during a time period in which the gesture control is active and the user rapidly releases the element control gesture or performs a complex movement that includes a rapid motion that is not intended to be a control gesture. This can often coincide, for example, with a drop of the user's arm, or other rapid motion of the electronic device 107 when the electronic device 107 is worn on the user's wrist. In one or more implementations, the electronic device 107 may detect (e.g., using an accelerometer and/or a gyroscope, such as with or without providing the accelerometer and/or gyroscope data to a machine learning model) motion of the electronic device 107 greater than a threshold amount of motion, and may temporarily disable or lock gesture-based control while the motion of the device is greater than the threshold amount of motion. In this example, gesture-based control can be resumed when the motion of the electronic device 107 falls below the threshold amount of motion.

In one or more use cases, even when the motion of the device is below the threshold amount of motion for disabling or locking gesture-based control, motion of the device that includes the sensors for gesture detection during gesture-based control operations can affect the process of gesture detection. For example, when the sensors are part of a smartwatch or other wearable device, sensors (e.g., EMG sensors) can be temporarily dislodged from a sensing position relative to the skin of the user/wearer. In one or more implementations, an electronic device, such as the electronic device 107, can modify the gesture prediction and/or gesture detection operations based on an amount of motion of the electronic device 107 (e.g., while the amount of motion changes and remains below the threshold amount of motion that causes locking or disabling of gesture control).

For example, the electronic device 107 may obtain motion information (e.g., IMU data, such as accelerometer data and/or gyroscope data) from a motion sensor (e.g., an IMU sensor, such as an accelerometer or a gyroscope) of the device. Based on the motion information, the electronic device may modify the gesture-detection sensitivity threshold.

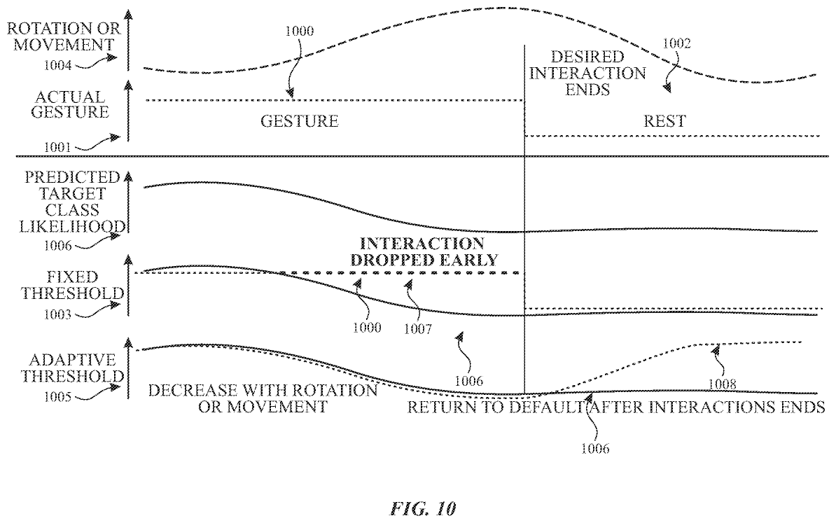

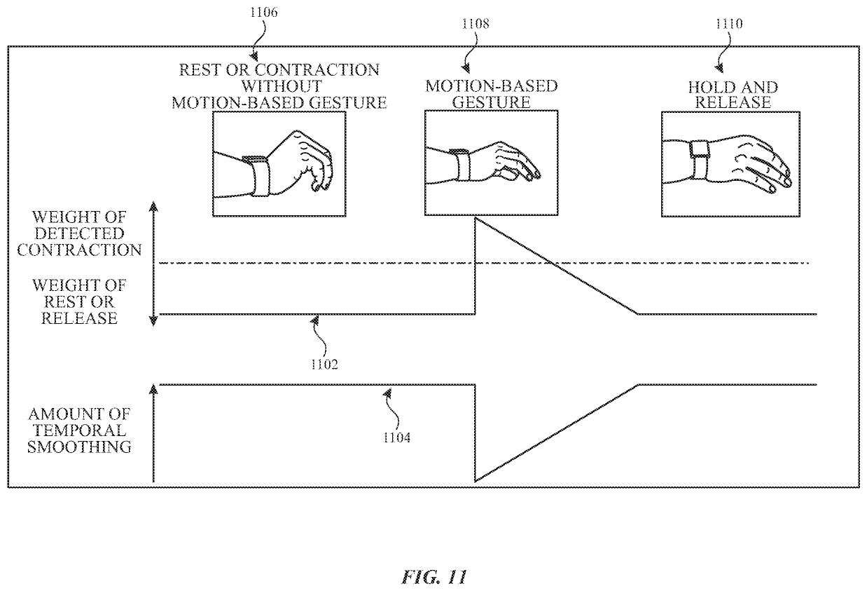

FIG. 10 illustrates an example of how a gesture-detection sensitivity threshold can be modified based on device motion, such as to mitigate an effect of motion of the device on gesture detection operations. In the example of FIG. 10, a timeline 1001 indicates a first period of time 1000 when an element control gesture is being performed, and second period of time 1002 when no gesture is being performed (e.g., the user/wearer is resting). FIG. 10 also includes a timeline 1004 indicating an amount of motion of the electronic device, and a timeline 1006 indicating a dynamically updating likelihood of the element control gesture, through the first period of time 1000 and the second period of time 1002. As shown, as the amount of motion increases, the likelihood of the element control gesture can decrease, even though the element control gesture is being performed during the first period of time 1000.

As shown in a timeline 1003, when the likelihood decreases due to the device motion, the electronic device may, during a period of time 1007 within the first period of time 1000 during which the element control gesture is being performed, determine incorrectly that no element control gesture is being performed. In the timeline 1005 of FIG. 10, it can be seen that, by dynamically updating the gesture-detection sensitivity threshold 1008 inversely to the device motion, the likelihood can decrease due to the device motion, which still remaining above the gesture-detection sensitivity threshold 1008. As shown, in one or more use cases, modifying the gesture-detection sensitivity threshold 1008 may include decreasing the gesture-detection sensitivity threshold 1008 responsive to an increase in motion of the device indicted by the motion information. In one or more implementations, modifying the gesture-detection sensitivity threshold 1008 based on the motion information may only occur upon and/or after gesture-based control is activated. As shown in FIG. 10, due to the actual release of the element control gesture, the electronic device 107 may deactivate the gesture-based control, and the gesture-detection sensitivity threshold 1008 may increase again smoothly over time, until reaching the initial gesture-detection sensitivity threshold 1008. The initial value may be a constant value of the gesture-detection sensitivity threshold that is maintained when gesture-detection is inactive.

In one or more implementations, the gesture control system 701 may be modified responsive to a trigger for gesture-based control. In various implementations, the trigger may be an activation gesture, a voice input, or other trigger. FIG. 11 illustrates an implementation in which an initial detection of an activation gesture (which may be the same as or different from the element control gesture) can cause an electronic device such as the electronic device 107 to modify the gesture control system 701 (e.g., by modifying the machine learning system 700 and/or the gesture detector 730) to emphasize detection of an element control gesture.

In the example of FIG. 11, a weight 1102 associated with detection of an element control gesture can be modified upon detection of a motion-based gesture. For example, prior to detection of a motion-based gesture (e.g., a pinch or a tap) to activate gesture-based control (e.g., while the user is in a resting state 1106), the weight 1102 may have a first value that emphasizes detection of a rest or release gesture over detection of an element control gesture. As shown, upon activating the gesture-based control responsive to detection of a motion-based gesture 1108, the electronic device may modify the weight 1102 to a second value that encourages detection of a hold of the element control gesture over detection of a rest or release gesture. As examples, the weight 1102 may be applied to the probabilities output by the machine learning system 700, to the likelihood output by the gesture detector 730, and/or within the gesture prediction model 724 in various implementations. As shown, after modifying the weight 1102 to the second value that encourages detection of the hold of the element control gesture, the electronic device may decrease the value of the weight, smoothly over a period of time, to the first value. In this way, when a release 1110 of the element control gesture is performed after gesture-based control, the electronic device 107 may be arranged to emphasize detection of the release, or rest.

FIG. 11 also shows how an amount 1104 of temporal smoothing may be adjusted. As shown, prior to activating the gesture-based control responsive to the motion-based gesture 1108, the electronic device 107 (e.g., the machine learning system 700 and/or the gesture detector 730) may apply a first amount of temporal smoothing to the determination of the likelihood (e.g., to the dynamically updating likelihood itself, or to the gesture probabilities and/or the sensor data upon which the likelihood is based). Upon activating the gesture-based control (e.g., responsive to the motion-based gesture 1108), the electronic device 107 may reduce the temporal smoothing to a second amount lower than the first amount. As shown, after reducing the temporal smoothing to the second amount, the electronic device 107 may increase the temporal smoothing, smoothly over a period of time, to the first amount.

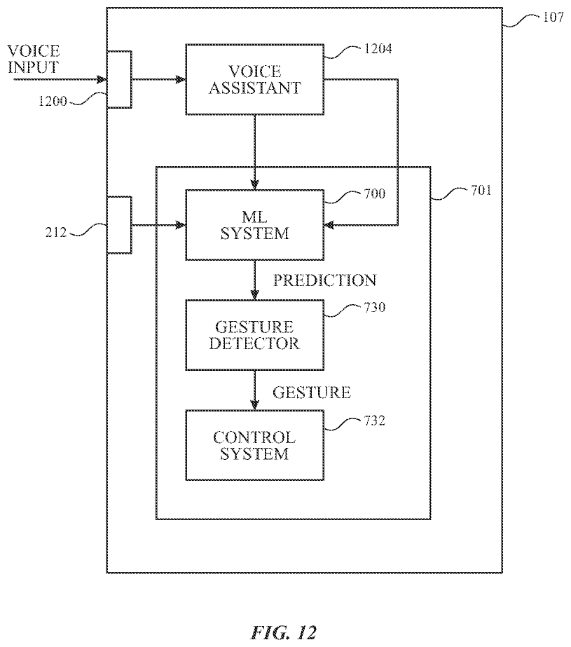

In the example of FIG. 11, a motion-based gesture is used to trigger gesture-based control of an electronic device. In one or more other implementations, a voice input may be used as a trigger for gesture based control. For example, FIG. 12 illustrates an implementation in which a voice input to the electronic device 107 is used to initiate gesture-based control.

As shown in FIG. 12, in one or more implementations, the electronic device 107 may receive a voice input (e.g., with a microphone 1200, which may be implemented as one of the sensor(s) 212 of FIG. 2). The voice input may include a trigger phrase (e.g., “Hey Assistant”) that activates a voice assistant application 1204 at the electronic device to process a command phrase. The voice input may also include a command phrase to activate a particular type of gesture-based control. As examples, the voice input may include the phase, “Hey Assistant, please hand me the volume controller”, “Hey Assistant, please hand me the scrolling controller”, or “Hey Assistant, please hand me the remote control”. The voice assistant application 1204 and/or the ML system 700 may identify a (e.g., virtual) controller of the electronic device 107 or another electronic device (e.g., electronic device 106) and determine that a particular element control gesture or set of element control gestures correspond to the controller requested in the voice input.

For example, the voice assistant application 1204 may provide an indication to the ML system 700 and/or the gesture detector 730 of the identified controller and/or one or more corresponding element control gestures for the identified controller. In one or more implementations, the electronic device 107 may modify, based on the identified controller and/or the corresponding gesture(s), the gesture control system 701 (e.g., the gesture detector 730 or the ML system 700) that is trained to identify one or more gestures based on sensor data from one or more sensors.

The gesture detector 730 may then determine a likelihood of the element control gesture being performed by a user based on an output of the modified gesture detection system, and the control system 732 may performing one or more device control operations to control the electronic device 107 or the other device (e.g., a second device different from the electronic device 107, such as the electronic device 106 or another device) based on the likelihood of the element control gesture being performed by the user. In one or more implementations, modifying the gesture detection system may include reducing the gesture-detection sensitivity threshold for the element control gesture. In one or more implementations, modifying the gesture detection system may include modifying a weight that is applied to the likelihood by the gesture detection system (e.g., by the gesture detector 730). In one or more implementations, modifying the gesture detection system may include modifying one or more weights of one or more trained machine learning models (e.g., gesture prediction model 724) of the machine learning system.

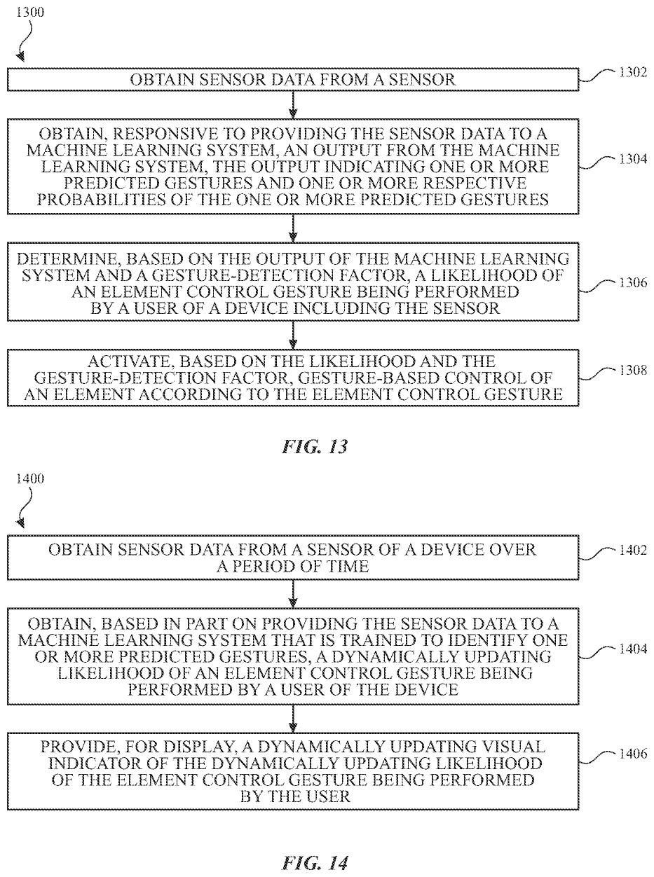

FIG. 13 illustrates a flow diagram of an example process 1300 for probabilistic gesture control, in accordance with one or more implementations. For explanatory purposes, the process 1300 is primarily described herein with reference to the electronic device 107 of FIG. 1. However, the process 1300 is not limited to the electronic device 107 of FIG. 1, and one or more blocks (or operations) of the process 1300 may be performed by one or more other components and/or other suitable devices. Further for explanatory purposes, the blocks of the process 1300 are described herein as occurring in serial, or linearly. However, multiple blocks of the process 1300 may occur in parallel. In addition, the blocks of the process 1300 need not be performed in the order shown and/or one or more blocks of the process 1300 need not be performed and/or can be replaced by other operations.

In the example of FIG. 13, at block 1302, the process 1300 includes obtaining sensor data from a sensor (e.g., sensor data 702, sensor data 704, and/or sensor data 706 from one or more of sensor(s) 212). The sensor(s) may be implemented in the device (e.g., device 200 such as electronic device 107) obtaining the sensor data, and/or sensor data may be obtained from one or more sensors in one or more other electronic devices.

At block 1304, responsive to providing the sensor data to a machine learning system (e.g., machine learning system 700), an output (e.g., a prediction, such as prediction 726) may be obtained from the machine learning system. The output may indicate one or more predicted gestures and one or more respective probabilities of the one or more predicted gestures. In one or more implementations, the output may include multiple predicted gestures and multiple corresponding probabilities for that predicted gesture. For example, the output may include a first probability that an element control gesture (e.g., a pinch-and-hold gesture or other element control gesture) is being (or is about to be) performed by a user of the device, and a second probability that a release gesture or no gesture is being (or is about to be) performed.

At block 1306, based on the output of the machine learning system and a gesture-detection factor, a likelihood of an element control gesture being performed by a user of a device including the sensor may be determined. For example, the gesture-detection factor may include a gesture-detection sensitivity threshold and/or a likelihood adjustment factor. In one or more implementations, the gesture-detection sensitivity threshold may be adjustable by the device (e.g., based on motion of the device) and/or by a user of the device (e.g., to increase or decrease the sensitivity to detection of element control gestures). As one illustrative example, the element control gesture may be a pinch-and-hold gesture.

In one or more implementations, determining the likelihood based on the output and the gesture-detection factor may include determining that a first one of the one or more respective probabilities that corresponds to the element control gesture is a highest one of the one or more respective probabilities, and increasing the likelihood by an amount corresponding to a higher of the first one of the one or more respective probabilities and a fraction (e.g., a quarter, half, etc.) of the gesture-detection sensitivity threshold. For example, the electronic device 107 may increase the likelihood of a pinch-and-hold gesture by amount that corresponds to a higher of the probability of the pinch-and-hold gesture and half of the gesture-detection sensitivity threshold.

In one or more use cases, determining the likelihood based on the output and the gesture-detection factor may also include, after determining that the first one of the one or more respective probabilities that corresponds to the element control gesture is the highest one of the one or more respective probabilities, determining that a second one of the one or more respective probabilities that corresponds to a gesture other than the element control gesture is the highest one of the one or more respective probabilities, and decreasing the likelihood by an amount corresponding to a higher of the second one of the one or more respective probabilities and a fraction (e.g., a quarter, half, etc.) of the gesture-detection sensitivity threshold. For example, after the pinch-and-hold gesture has been detected (e.g., as the pinch-and-hold gesture is being released), the electronic device 107 may determine that a probability of a release gesture is higher than the probability of the pinch-and-hold gesture, and the electronic device 107 may decrease the likelihood of the pinch-and-hold gesture by an amount, such as a higher of the probability of the release gesture and a faction of the gesture-detection sensitivity threshold.

At block 1308, the process 1300 may include activating, based on the likelihood and the gesture-detection factor, gesture-based control of an element according to the element control gesture. For example, activating the gesture-based control of the element based on the likelihood and the gesture-detection factor may include activating the gesture-based control of the element based on a comparison of the likelihood with the gesture-detection sensitivity threshold. In one or more implementations, the element may include a virtual knob, a virtual dial, a virtual slider, or a virtual remote control. In examples in which the element is a virtual remote control, the virtual remote control may have multiple associated element control gestures that can be detected by the gesture-detection system, such as a button press gesture and a swipe gesture. In one or more implementations, the device may be a first device, and activating the gesture-based control of the element according to the element control gesture may include activating the gesture-based control of the element at the first device or at a second device different from the first device.

In one or more implementations, the process 1300 may also include obtaining motion information from a motion sensor (e.g., an accelerometer and/or a gyroscope) of the device, and modifying the gesture-detection sensitivity threshold based on the motion information. For example, modifying the gesture-detection sensitivity threshold may include decreasing the gesture-detection sensitivity threshold responsive to an increase in motion of the device (e.g., due to movement of the device relative to the user and/or the user's skin resulting from the motion of the user's arm while performing the element control gesture) indicated by the motion information (e.g., as described herein in connection with FIG. 10).

In one or more implementations, modifying the gesture-detection sensitivity threshold based on the motion information may include modifying the gesture-detection sensitivity threshold based on the motion information upon activation of the gesture-based control. In one or more implementations, the process 1300 may also include (e.g., deactivating the gesture-based control and) smoothly increasing the gesture-detection sensitivity threshold to an initial value after deactivating the gesture-based control (e.g., as described herein in connection with FIG. 10).

In one or more implementations, obtaining the sensor data from the sensor at block 1302 includes obtaining first sensor data (e.g., sensor data 702 of FIG. 7) from a first sensor (e.g., an accelerometer) of the device, and the process 1300 also includes obtaining second sensor data (e.g., sensor data 706) from a second sensor (e.g., an EMG sensor) of the device. In these implementations, obtaining the output indicating the one or more predicted gestures and the one or more respective probabilities of the one or more predicted gestures may include providing the first sensor data to a first machine learning model (e.g., machine learning model 708) trained to extract first features (e.g., feature vector 714) from a first type of sensor data (e.g., accelerometer data), providing the second sensor data to a second machine learning model (e.g., machine learning model 712) trained to extract second features (e.g., feature vector 718) from a second type of sensor data (e.g., EMG data), combining a first output (e.g., feature vector 714) of the first machine learning model with a second output (e.g., feature vector 718) of the second machine learning model to generate a combined sensor input (e.g., combined input vector 722), and obtaining the output (e.g., the prediction 726) indicating the one or more predicted gestures and the one or more respective probabilities of the one or more predicted gestures from a third machine learning model (e.g., gesture prediction model 724) responsive to providing the combined sensor input to the third machine learning model (e.g., as illustrated in FIG. 7).

In one or more implementations, the first sensor data has a first characteristic amount of noise (e.g., relatively low noise accelerometer data) and the second sensor data has a second characteristic amount of noise (e.g., relatively higher noise EMG data) higher than the first characteristic amount of noise, and the machine learning system includes at least one processing module (e.g., a modality dropout module of the intermediate processing operations 720) interposed between the third machine learning model and the first and second machine learning model, the at least one processing module configured to emphasize (e.g., in some training runs for the gesture prediction model 724) the second sensor data having the second characteristic amount of noise higher than the first characteristic amount of noise (e.g., as discussed in connection with FIG. 7).

In one or more implementations, the process 1300 may also include providing (e.g., by the first device or the second device), at least one of a visual indicator based on the likelihood, a haptic indicator based on the likelihood, or an auditory indicator based on the likelihood (e.g., as described herein in connection with FIGS. 4, 5, 6, 8, and/or 9). In one or more implementations, the process 1300 also includes detecting motion of the device greater than a threshold amount of motion (e.g., due to a wearer of a smartwatch dropping their arm) and disabling the gesture-based control of the element while the motion of the device is greater than the threshold amount of motion. In this way, erroneous large adjustments of the element that are not intended by the user can be avoided.

FIG. 14 illustrates a flow diagram of an example process 1400 for gesture control with feedback, in accordance with one or more implementations. For explanatory purposes, the process 1400 is primarily described herein with reference to the electronic device 107 of FIG. 1. However, the process 1400 is not limited to the electronic device 107 of FIG. 1, and one or more blocks (or operations) of the process 1400 may be performed by one or more other components and/or other suitable devices. Further for explanatory purposes, the blocks of the process 1400 are described herein as occurring in serial, or linearly. However, multiple blocks of the process 1400 may occur in parallel. In addition, the blocks of the process 1400 need not be performed in the order shown and/or one or more blocks of the process 1400 need not be performed and/or can be replaced by other operations.

In the example of FIG. 14, at block 1402, an electronic device (e.g., device 200 such as electronic device 107) may obtain sensor data from a sensor of the device over a period of time. As examples, the sensor data may include sensor data 702, sensor data 704, and/or sensor data 706 from one or more of sensor(s) 212. One or more of the sensor(s) may be implemented in the device obtaining the sensor data, and/or sensor data may be obtained from one or more sensors in one or more other electronic devices.

At block 1404, the electronic device may obtain, based in part on providing the sensor data to a gesture control system (e.g., gesture control system 701) comprising a machine learning system (e.g., machine learning system 700) that is trained to identify one or more predicted gestures, a dynamically updating likelihood of an element control gesture being performed by a user of the device. The dynamically updating likelihood may be dynamically updated in accordance with changes in the sensor data during the period of time.

At block 1406, the electronic device may provide, for display, a dynamically updating visual indicator (e.g., visual indicator 402) of the dynamically updating likelihood of the element control gesture being performed by the user. In one or more implementations, providing the dynamically updating visual indicator for display may include providing the dynamically updating visual indicator for display at the device or at a second device (e.g., the electronic device 106) different from the device, and the process 1400 may also include displaying the dynamically updating visual indicator at the device or the second device different from the first device.

In one or more implementations, providing the dynamically updating visual indicator may include dynamically scaling an overall size of the visual indicator with the dynamically updating likelihood (e.g., a described herein in connection with FIGS. 4-6, 7, and/or 8). For example, dynamically scaling the overall size of the visual indicator with the dynamically updating likelihood may include determining (e.g., by gesture detector 730) an increased or decreased likelihood of the element control gesture being performed by the user of the device, and increasing or decreasing (e.g., by an amount corresponding to the amount of the increased or decreased likelihood) the overall size of the visual indicator according to the increased or decreased likelihood. As discussed herein in connection with FIGS. 4-6, 8, and 9, increasing or decreasing the overall size of the visual indicator may include increasing the linear/transverse or circumferential length of the visual indicator (see, e.g., FIGS. 4-6) and/or may include increasing or decreasing the overall (e.g., average or median) radial length of one or more indicator components that make up the visual indicator (see, e.g., FIGS. 8 and/or 9).

In one or more implementations, the dynamically updating visual indicator may include a plurality of distinct visual indicator components (e.g., visual indicator components 802) having a plurality of respective component sizes, and providing the dynamically updating visual indicator may also include dynamically varying the plurality of respective component sizes by an amount that scales inversely with the dynamically updating likelihood (e.g., as described in FIGS. 8 and/or 9). For example, during a period of time during which each new value of the likelihood is higher than the previous value of the likelihood, the overall (e.g., average or median) length of the visual indicator components may increase, scaling with the increasing likelihood, and the amount of variance in the individual lengths of the visual indicator components may decrease, scaling inversely with the increasing likelihood. Conversely, during a period of time during which each new value of the likelihood is lower than the previous value of the likelihood, the overall (e.g., average or median) length of the visual indicator components may decrease, scaling with the decreasing likelihood, and the amount of variance in the individual lengths of the visual indicator components may increase, scaling inversely with the decreasing likelihood.

In one or more implementations, the process 1400 may also include determining that the dynamically updating likelihood exceeds a threshold likelihood and, responsively: setting the overall size of the visual indicator to a maximum overall size (e.g., a full circumferential extent or linear transverse length as in the example of FIG. 5), setting the plurality of respective component sizes to a maximum overall component size (e.g., a full radial length as in the example of state 402-3 of FIG. 8), and activating gesture-based control of an element according to the element control gesture. For example, the element may be an element of the device, a second device different from the device, or a third device different from the device and the second device. Once the gesture-based control is activated, changes or motions in the element control gesture can cause changes to the visual representation of the element (e.g., the virtual dial) and the underlying device behavior, whereas prior to activation of gesture-base control, changes and/or motions in a gesture may not be used to cause changes to the visual representation of the element (e.g., the virtual dial) or the underlying device behavior. In one or more implementations, setting the plurality of respective component sizes to the maximum overall component size may include setting a subset (e.g., subset 902) of the plurality of respective component sizes of a respective subset of the plurality of distinct visual indicator components to a first maximum overall component size that is larger than a second maximum component size of a remainder of the plurality of respective component sizes. For example, the respective subset of the plurality of distinct visual indicator components may have a location within the visual indicator, the location corresponding to an orientation of the element control gesture being performed by the user (e.g., as described herein in connection with FIG. 9).

In one or more implementations, the process 1400 may include dynamically determining a changing orientation of the element control gesture (e.g., using the gesture control system 701 as the user performs a rotation or a pan motion while holding a pinch gesture), and modifying the location of the respective subset of the plurality of distinct visual indicator components based on the changing orientation (e.g., to make the visual indicator appear to rotate with the rotation of the user's gesture, such as in the example of state 402-4 of FIG. 9).

In one or more implementations, the process 1400 may also include effecting the gesture-based control of the element according to the changing orientation. For example, effecting the gesture-based control may include raising or lowering the volume of audio output generated by the device displaying the visual indicator or another device (e.g., a second device different from the first device), scrolling through audio or video content using the device displaying the visual indicator or another device (e.g., a second device different from the first device), raising or lowering the brightness of a light source, etc.

In one or more implementations, the visual indicator includes an indicator (e.g., indicator 904) of a current setting of the element, and effecting the gesture-based control of the element may include dynamically updating a location of the indicator by an amount that corresponds to an amount of change of the changing orientation relative to an initial orientation of the element control gesture when the dynamically updating likelihood reaches the threshold likelihood (e.g., using the relative adjustment operations described herein in connection with FIG. 9). In one or more other implementations, the visual indicator includes an indicator (e.g., indicator 904) of a current setting of the element, and effecting the gesture-based control of the element includes dynamically updating a location of the indicator based on a difference between the location of the indicator and the orientation of the element control gesture (e.g., using the operations described herein in connection with FIG. 9). In one or more implementations, a confirmatory animation of the visual indicator can also be performed when the dynamically updating likelihood reaches the threshold likelihood.

FIG. 15 illustrates a flow diagram of an example process 1500 for voice-triggered gesture control, in accordance with one or more implementations. For explanatory purposes, the process 1500 is primarily described herein with reference to the electronic device 107 of FIG. 1. However, the process 1500 is not limited to the electronic device 107 of FIG. 1, and one or more blocks (or operations) of the process 1500 may be performed by one or more other components and/or other suitable devices. Further for explanatory purposes, the blocks of the process 1500 are described herein as occurring in serial, or linearly. However, multiple blocks of the process 1500 may occur in parallel. In addition, the blocks of the process 1500 need not be performed in the order shown and/or one or more blocks of the process 1500 need not be performed and/or can be replaced by other operations.

In the example of FIG. 15, at block 1502, a device (e.g., device 200 such as electronic device 107) may receive a voice input. For example, the voice input may be received using a microphone (e.g., microphone 1200) of the device, or may be received from another device via a microphone of the other device. The voice input may be provided to a voice assistant application at the device (e.g., as discussed herein in connection with FIG. 12).

At block 1504, based on the voice input, a controller (e.g., a virtual controller) may be identified, the controller associated with an element control gesture. As examples, the controller may include a rotatable virtual control element controllable by a rotational element control gesture, a linearly moveable virtual control element controllable by a linear element control gesture, or a virtual remote control having multiple virtual control elements controllable by multiple respective element control gestures.

At block 1506, the device may modify, based on the identified controller, a gesture control system that is trained to identify one or more gestures based on sensor data from one or more sensors (e.g., as described herein in connection with FIG. 12). For example, modifying the gesture control system may include reducing (e.g., by the gesture detector 730) a threshold (e.g., a gesture-detection sensitivity threshold) for the element control gesture. As another example, modifying the gesture control system may include modifying a weight that is applied to the likelihood by the gesture control system (e.g., by the gesture detector 730). For example, modifying the weight may include modifying the weight as described herein in connection with FIG. 11. As another example, modifying the gesture control system may include modifying a machine learning system (e.g., machine learning system 700) of the gesture control system. For example, modifying the machine learning system may include modifying one or more weights of one or more trained machine learning models (e.g., gesture prediction model 724) of the machine learning system of the gesture control system.

At block 1508, the device (e.g., machine learning system 700 and/or gesture detector 730) may determine a likelihood of the element control gesture being performed by a user based on an output of the modified gesture control system (e.g., as described herein in connection with FIG. 7 and/or FIG. 12).

At block 1510, the process 1500 may include performing a control operation based on the likelihood of the element control gesture being performed by the user. For example, the control operation may include displaying (e.g., at the device or a second device different from the device, such as the electronic device 106) a visual indicator of the likelihood (e.g., as described herein in connection with FIGS. 4, 5, 6, 8, 9, and/or 14). In one or more implementations, the control operation may include activating a gesture-based control of the controller when the likelihood exceeds a threshold (e.g., the gesture-detection sensitivity threshold).

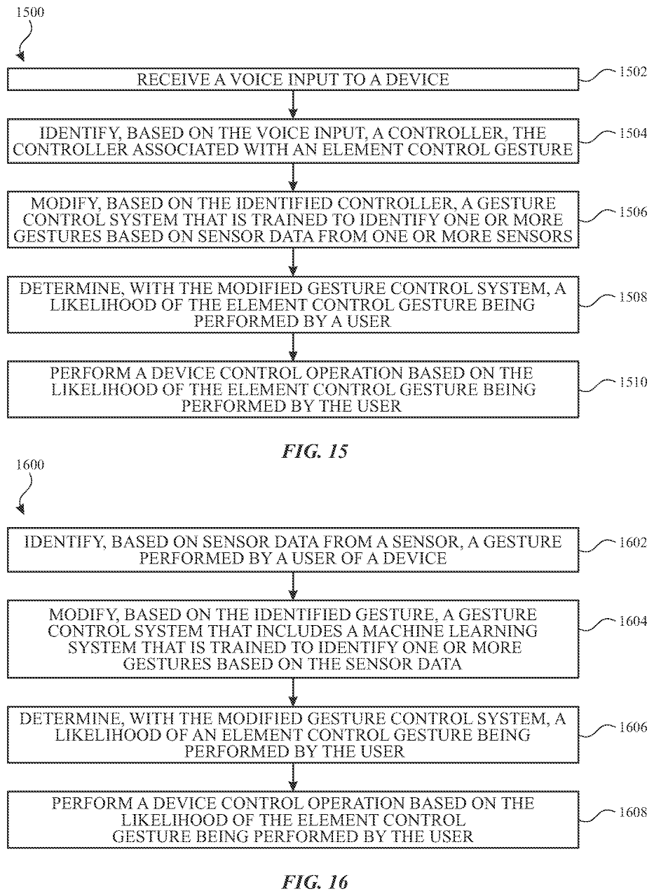

FIG. 16 illustrates a flow diagram of an example process 1600 for gesture-triggered gesture control, in accordance with one or more implementations. For explanatory purposes, the process 1600 is primarily described herein with reference to the electronic device 107 of FIG. 1. However, the process 1600 is not limited to the electronic device 107 of FIG. 1, and one or more blocks (or operations) of the process 1600 may be performed by one or more other components and/or other suitable devices. Further for explanatory purposes, the blocks of the process 1600 are described herein as occurring in serial, or linearly. However, multiple blocks of the process 1600 may occur in parallel. In addition, the blocks of the process 1600 need not be performed in the order shown and/or one or more blocks of the process 1600 need not be performed and/or can be replaced by other operations.

In the example of FIG. 16, at block 1602, a device (e.g., device 200 such as electronic device 107) may identify, based on sensor data from a sensor, a gesture performed by a user of a device. For example, the gesture may be a motion-based gesture, such as motion-based gesture 1108 of FIG. 11. The motion-based gesture may be the same as an element control gesture, or may be a different gesture that can be performed to initiate gesture-based control with the element control gesture.

At block 1604, the device may modify, based on the identified gesture, a gesture control system (e.g., gesture control system 701) that includes a machine learning system (e.g., machine learning system 700) that is trained to identify one or more gestures based on the sensor data. For example, modifying the gesture control system may include reducing a threshold for the element control gesture (e.g., a gesture-detection sensitivity threshold). As another example, modifying the gesture control system may include modifying the machine learning system. For example, modifying the machine learning system may include modifying one or more weights of one or more trained machine learning models (e.g., gesture prediction model 724) of the machine learning system of the gesture control system.

As another example, modifying the gesture control system may include modifying a weight that is applied to the likelihood by the gesture control system (e.g., by the gesture detector 730). For example, modifying the weight may include modifying the weight as described herein in connection with FIG. 11. In one or more implementations, the process 1600 may also include, prior to activating the gesture-based control, applying a weight (e.g., weight 1102) to the likelihood, the weight having a first value that encourages detection of a gesture other than the element control gesture; and upon activating the gesture-based control (e.g., by performing an activation gesture, or through a voice command), modifying the weight to a second value that encourages detection of a hold of the element control gesture and/or a detection of an element control gesture (e.g., a pinch-and-hold gesture) over the gesture other than the element control gesture. For example, the gesture other than the element control gesture may include a release gesture or a resting gesture (e.g., a lack of a gesture). In one or more implementations, after modifying the weight to the second value that encourages detection of the hold of the element control gesture or the element control gesture, the gesture control system may decrease the value of the weight, smoothly over a period of time, to the first value.

In one or more implementations, prior to activating the gesture-based control, the device may apply a first amount of temporal smoothing to the determination of the likelihood and, upon activating the gesture-based control, reduce the temporal smoothing to a second amount lower than the first amount (e.g., as described herein in connection with FIG. 11). In one or more implementations, after reducing the temporal smoothing to the second amount, the device may increase the temporal smoothing, smoothly over a period of time, to the first amount.

At block 1606, the device (e.g., machine learning system 700 and/or gesture detector 730) may determine a likelihood of an element control gesture being performed by the user based on an output of the modified gesture control system. For example, the likelihood may be determined by the gesture detector 730 as described herein in connection with FIG. 7.

At block 1608, the process 1600 may include performing a device control operation (e.g., for controlling the device or a second device different from the device) based on the likelihood of the element control gesture being performed by the user. For example, the device control operation may include activating gesture-based control of the device or a second device different from the first device when the likelihood of the element control gesture exceeds a threshold (e.g., a gesture-detection sensitivity threshold). As another example, the device control operation may include displaying a visual indicator of the likelihood at the device or a second device different from the first device (e.g., as described herein in connection with FIGS. 4, 5, 6, 8, 9, and/or 14). As another example, the device control operation may also include modifying an output (e.g., audio output, video output, light output) of the device or a second device different from the first device according to the element control gesture.

FIG. 17 illustrates a flow diagram of an example process 1700 for probabilistic gesture control with visual feedback, in accordance with one or more implementations. For explanatory purposes, the process 1700 is primarily described herein with reference to the electronic device 107 of FIG. 1. However, the process 1700 is not limited to the electronic device 107 of FIG. 1, and one or more blocks (or operations) of the process 1700 may be performed by one or more other components and/or other suitable devices. Further for explanatory purposes, the blocks of the process 1700 are described herein as occurring in serial, or linearly. However, multiple blocks of the process 1700 may occur in parallel. In addition, the blocks of the process 1700 need not be performed in the order shown and/or one or more blocks of the process 1700 need not be performed and/or can be replaced by other operations.

In the example of FIG. 17, at block 1702, the process 1700 includes obtaining sensor data from a sensor (e.g., sensor data 702, sensor data 704, and/or sensor data 706 from one or more of sensor(s) 212). The sensor(s) may be implemented in the device (e.g., device 200 such as electronic device 107) obtaining the sensor data, and/or sensor data may be obtained from one or more sensors in one or more other electronic devices.

At block 1704, responsive to providing the sensor data to a machine learning system (e.g., machine learning system 700), an output (e.g., a prediction, such as prediction 726) may be obtained from the machine learning system. The output may indicate one or more predicted gestures and one or more respective probabilities of the one or more predicted gestures. In one or more implementations, the output may include multiple predicted gestures and multiple corresponding probabilities for that predicted gesture. For example, the output may include a first probability that an element control gesture (e.g., a pinch-and-hold gesture or other element control gesture) is being (or is about to be) performed by a user of the device, and a second probability that a release gesture or no gesture is being (or is about to be) performed.

At block 1706, the electronic device (e.g., gesture detector 730) may determine, based on the output of the machine learning system and a gesture-detection factor (e.g., a gesture-detection sensitivity threshold) a dynamically updating likelihood of an element control gesture being performed by a user of a first device. The dynamically updating likelihood may be dynamically updated in accordance with changes in the sensor data during the period of time.

At block 1708, the electronic device may provide, for display, a dynamically updating visual indicator (e.g., visual indicator 402) of the dynamically updating likelihood of the element control gesture being performed by the user. In one or more implementations, providing the dynamically updating visual indicator for display may include providing the dynamically updating visual indicator for display at the device or at a second device (e.g., the electronic device 106) different from the device, and the process 1700 may also include displaying the dynamically updating visual indicator at the device or the second device different from the first device.

In one or more implementations, providing the dynamically updating visual indicator may include dynamically scaling an overall size of the visual indicator with the dynamically updating likelihood (e.g., a described herein in connection with FIGS. 4-6, 7, and/or 8). For example, dynamically scaling the overall size of the visual indicator with the dynamically updating likelihood may include determining (e.g., by gesture detector 730) an increased or decreased likelihood of the element control gesture being performed by the user of the device, and increasing or decreasing (e.g., by an amount corresponding to the amount of the increased or decreased likelihood) the overall size of the visual indicator according to the increased or decreased likelihood. As discussed herein in connection with FIGS. 4-6, 8, 9, and 14, increasing or decreasing the overall size of the visual indicator may include increasing the linear/transverse or circumferential length of the visual indicator (see, e.g., FIGS. 4-6) and/or may include increasing or decreasing the overall (e.g., average or median) radial length of one or more indicator components that make up the visual indicator (see, e.g., FIGS. 8 and/or 9).

In one or more implementations, the dynamically updating visual indicator may include a plurality of distinct visual indicator components (e.g., visual indicator components 802) having a plurality of respective component sizes, and providing the dynamically updating visual indicator may also include dynamically varying the plurality of respective component sizes by an amount that scales inversely with the dynamically updating likelihood (e.g., as described in FIGS. 8 and/or 9).

In one or more implementations, the process 1700 may also include performing gesture control of an element at the first device or a second device different from the first device (e.g., by increasing or decreasing an audio output volume, scrolling through content, such as audio or video content, controlling a light source, or the like).

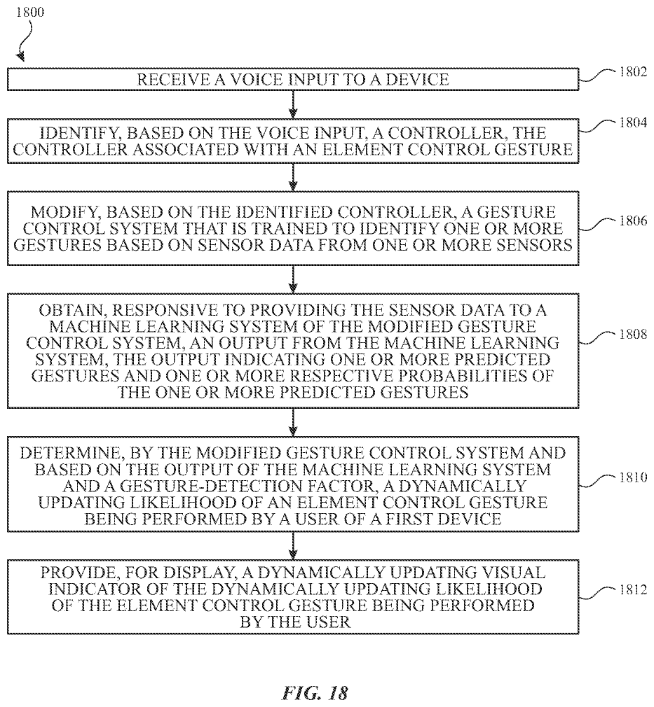

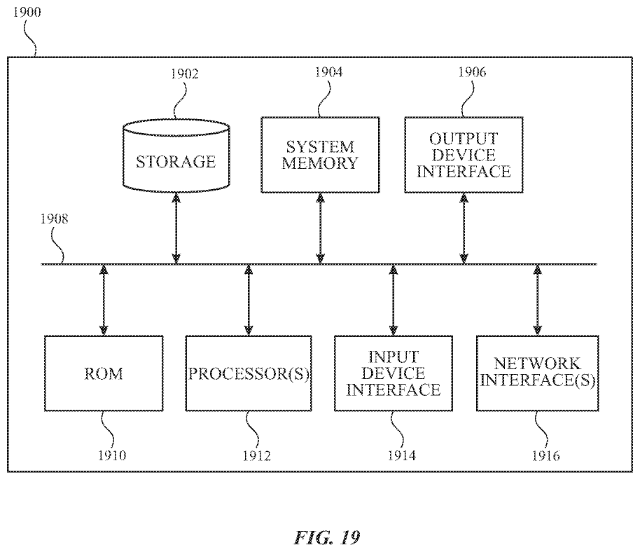

FIG. 18 illustrates a flow diagram of an example process 1800 for voice-triggered probabilistic gesture control with visual feedback, in accordance with one or more implementations. For explanatory purposes, the process 1800 is primarily described herein with reference to the electronic device 107 of FIG. 1. However, the process 1800 is not limited to the electronic device 107 of FIG. 1, and one or more blocks (or operations) of the process 1800 may be performed by one or more other components and/or other suitable devices. Further for explanatory purposes, the blocks of the process 1800 are described herein as occurring in serial, or linearly. However, multiple blocks of the process 1800 may occur in parallel. In addition, the blocks of the process 1800 need not be performed in the order shown and/or one or more blocks of the process 1800 need not be performed and/or can be replaced by other operations.

In the example of FIG. 18, at block 1802, a device (e.g., device 200 such as electronic device 107) may receive a voice input. For example, the voice input may be received using a microphone (e.g., microphone 1200) of the device, or may be received from another device via a microphone of the other device. The voice input may be provided to a voice assistant application at the device (e.g., as discussed herein in connection with FIG. 12 and/or FIG. 15).

At block 1804, based on the voice input, a controller (e.g., a virtual controller) may be identified, the controller associated with an element control gesture. As examples, the controller may include a rotatable virtual control element controllable by a rotational element control gesture, a linearly moveable virtual control element controllable by a linear element control gesture, or a virtual remote control having multiple virtual control elements controllable by multiple respective element control gestures.

At block 1806, the device may modify, based on the identified controller, a gesture control system that is trained to identify one or more gestures based on sensor data from one or more sensors (e.g., as described herein in connection with FIG. 12 and/or FIG. 15). For example, modifying the gesture control system may include reducing (e.g., by the gesture detector 730) a threshold (e.g., a gesture-detection sensitivity threshold) for the element control gesture. As another example, modifying the gesture control system may include modifying a weight that is applied to the likelihood by the gesture control system (e.g., by the gesture detector 730). For example, modifying the weight may include modifying the weight as described herein in connection with FIG. 11. As another example, modifying the gesture control system may include modifying a machine learning system (e.g., machine learning system 700) of the gesture control system. For example, modifying the machine learning system may include modifying one or more weights of one or more trained machine learning models (e.g., gesture prediction model 724) of the machine learning system of the gesture control system.

At block 1808, responsive to providing the sensor data to a machine learning system (e.g., machine learning system 700) of the modified gesture control system, an output (e.g., a prediction, such as prediction 726) may be obtained from the machine learning system. The output may indicate one or more predicted gestures and one or more respective probabilities of the one or more predicted gestures. In one or more implementations, the output may include multiple predicted gestures and multiple corresponding probabilities for that predicted gesture. For example, the output may include a first probability that an element control gesture (e.g., a pinch-and-hold gesture or other element control gesture) is being (or is about to be) performed by a user of the device, and a second probability that a release gesture or no gesture is being (or is about to be) performed.

At block 1810, the electronic device may determine, using the modified gesture control system and based on the output of the machine learning system and a gesture-detection factor (e.g., a gesture-detection sensitivity threshold) a dynamically updating likelihood of an element control gesture being performed by a user of a first device. The dynamically updating likelihood may be dynamically updated in accordance with changes in the sensor data during the period of time.

At block 1812, the electronic device may provide, for display, a dynamically updating visual indicator (e.g., visual indicator 402) of the dynamically updating likelihood of the element control gesture being performed by the user. In one or more implementations, providing the dynamically updating visual indicator for display may include providing the dynamically updating visual indicator for display at the device or at a second device (e.g., the electronic device 106) different from the device, and the process 1800 may also include displaying the dynamically updating visual indicator at the device or the second device different from the first device.

In one or more implementations, providing the dynamically updating visual indicator may include dynamically scaling an overall size of the visual indicator with the dynamically updating likelihood (e.g., a described herein in connection with FIGS. 4-6, 7, and/or 8). For example, dynamically scaling the overall size of the visual indicator with the dynamically updating likelihood may include determining (e.g., by gesture detector 730) an increased or decreased likelihood of the element control gesture being performed by the user of the device, and increasing or decreasing (e.g., by an amount corresponding to the amount of the increased or decreased likelihood) the overall size of the visual indicator according to the increased or decreased likelihood. As discussed herein in connection with FIGS. 4-6, 8, 9, 14 and 17, increasing or decreasing the overall size of the visual indicator may include increasing the linear/transverse or circumferential length of the visual indicator (see, e.g., FIGS. 4-6) and/or may include increasing or decreasing the overall (e.g., average or median) radial length of one or more indicator components that make up the visual indicator (see, e.g., FIGS. 8 and/or 9).

In one or more implementations, the process 1800 may also include performing gesture control of an element at the first device or a second device different from the first device (e.g., by increasing or decreasing an audio output volume, scrolling through content, such as audio or video content, controlling a light source, or the like).

As described above, one aspect of the present technology is the gathering and use of data available from specific and legitimate sources for probabilistic gesture control. The present disclosure contemplates that in some instances, this gathered data may include personal information data that uniquely identifies or can be used to identify a specific person. Such personal information data can include demographic data, location-based data, sensor data, gesture data, online identifiers, telephone numbers, email addresses, home addresses, device identifiers, data or records relating to a user's health or level of fitness (e.g., vital signs measurements, medication information, exercise information, EMG signals), date of birth, or any other personal information.

The present disclosure recognizes that the use of such personal information data, in the present technology, can be used to the benefit of users. For example, the personal information data can be used for providing probabilistic gesture control. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates aspects in which users selectively block the use of, or access to, personal information data. That is, the present disclosure contemplates that hardware and/or software elements can be provided to prevent or block access to such personal information data. For example, in the case of providing probabilistic gesture control, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 19 illustrates an electronic system 1900 with which one or more implementations of the subject technology may be implemented. The electronic system 1900 can be, and/or can be a part of, one or more of the electronic devices 102-107 and/or the server 114 shown in FIG. 1. The electronic system 1900 may include various types of computer readable media and interfaces for various other types of computer readable media. The electronic system 1900 includes a bus 1908, one or more processing unit(s) 1912, a system memory 1904 (and/or buffer), a ROM 1910, a permanent storage device 1902, an input device interface 1914, an output device interface 1906, and one or more network interfaces 1916, or subsets and variations thereof.

The bus 1908 collectively represents all system, peripheral, and chipset buses that communicatively connect the numerous internal devices of the electronic system 1900. In one or more implementations, the bus 1908 communicatively connects the one or more processing unit(s) 1912 with the ROM 1910, the system memory 1904, and the permanent storage device 1902. From these various memory units, the one or more processing unit(s) 1912 retrieves instructions to execute and data to process in order to execute the processes of the subject disclosure. The one or more processing unit(s) 1912 can be a single processor or a multi-core processor in different implementations.

The ROM 1910 stores static data and instructions that are needed by the one or more processing unit(s) 1912 and other modules of the electronic system 1900. The permanent storage device 1902, on the other hand, may be a read-and-write memory device. The permanent storage device 1902 may be a non-volatile memory unit that stores instructions and data even when the electronic system 1900 is off. In one or more implementations, a mass-storage device (such as a magnetic or optical disk and its corresponding disk drive) may be used as the permanent storage device 1902.

In one or more implementations, a removable storage device (such as a floppy disk, flash drive, and its corresponding disk drive) may be used as the permanent storage device 1902. Like the permanent storage device 1902, the system memory 1904 may be a read-and-write memory device. However, unlike the permanent storage device 1902, the system memory 1904 may be a volatile read-and-write memory, such as random-access memory. The system memory 1904 may store any of the instructions and data that one or more processing unit(s) 1912 may need at runtime. In one or more implementations, the processes of the subject disclosure are stored in the system memory 1904, the permanent storage device 1902, and/or the ROM 1910. From these various memory units, the one or more processing unit(s) 1912 retrieves instructions to execute and data to process in order to execute the processes of one or more implementations.

The bus 1908 also connects to the input and output device interfaces 1914 and 1906. The input device interface 1914 enables a user to communicate information and select commands to the electronic system 1900. Input devices that may be used with the input device interface 1914 may include, for example, microphones, alphanumeric keyboards, touchscreens, touchpads, and pointing devices (also called “cursor control devices”). The output device interface 1906 may enable, for example, the display of images generated by electronic system 1900. Output devices that may be used with the output device interface 1906 may include, for example, speakers, printers and display devices, such as a liquid crystal display (LCD), a light emitting diode (LED) display, an organic light emitting diode (OLED) display, a flexible display, a flat panel display, a solid state display, a projector, a light source, a haptic components, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 19, the bus 1908 also couples the electronic system 1900 to one or more networks and/or to one or more network nodes, such as the server 114 shown in FIG. 1, through the one or more network interface(s) 1916. In this manner, the electronic system 1900 can be a part of a network of computers (such as a LAN, a wide area network (“WAN”), or an Intranet, or a network of networks, such as the Internet. Any or all components of the electronic system 1900 can be used in conjunction with the subject disclosure.

In accordance with aspects of the disclosure, a method is provided that includes obtaining sensor data from a sensor; obtaining, responsive to providing the sensor data to a machine learning system, an output from the machine learning system, the output indicating one or more predicted gestures and one or more respective probabilities of the one or more predicted gestures; determining, based on the output of the machine learning system and a gesture-detection factor, a likelihood of an element control gesture being performed by a user of a device comprising the sensor; and activating, based on the likelihood and the gesture-detection factor, gesture-based control of an element according to the element control gesture.

In accordance with aspects of the disclosure, a method is provided that includes obtaining sensor data from a sensor of a device over a period of time; obtaining, based in part on providing the sensor data to gesture control system comprising a machine learning system that is trained to identify one or more predicted gestures, a dynamically updating likelihood of an element control gesture being performed by a user of the device; and providing, for display, a dynamically updating visual indicator of the dynamically updating likelihood of the element control gesture being performed by the user.

In accordance with aspects of the disclosure, a method is provided that includes receiving a voice input to a device; identifying, based on the voice input, a controller, the controller associated with an element control gesture; modifying, based on the identified controller, a gesture control system that is trained to identify one or more gestures based on sensor data from one or more sensors; determining, with the modified gesture control system, a likelihood of the element control gesture being performed by a user; and performing a control operation based on the likelihood of the element control gesture being performed by the user.

In accordance with aspects of the disclosure, a method is provided that includes identifying, based on sensor data from a sensor, a gesture performed by a user of a device; modifying, based on the identified gesture, a gesture control system comprising a machine learning system that is trained to identify one or more gestures based on the sensor data; determining, with the modified gesture control system, a likelihood of an element control gesture being performed by the user; and performing a device control operation based on the likelihood of the element control gesture being performed by the user.

In accordance with aspects of the disclosure, a method is provided that includes obtaining sensor data from a sensor; obtaining, responsive to providing the sensor data to a machine learning system, an output from the machine learning system, the output indicating one or more predicted gestures and one or more respective probabilities of the one or more predicted gestures; determining, based on the output of the machine learning system and a gesture-detection factor, a dynamically updating likelihood of an element control gesture being performed by a user of a first device; and providing, for display, a dynamically updating visual indicator of the dynamically updating likelihood of the element control gesture being performed by the user.

In accordance with aspects of the disclosure, a method is provided that includes receiving a voice input to a device; identifying, based on the voice input, a controller, the controller associated with an element control gesture; modifying, based on the identified controller, a gesture control system that is trained to identify one or more gestures based on sensor data from one or more sensors; obtaining, responsive to providing the sensor data to a machine learning system of the modified gesture control system, an output from the machine learning system, the output indicating one or more predicted gestures and one or more respective probabilities of the one or more predicted gestures; determining, by the modified gesture control system and based on the output of the machine learning system and a gesture-detection factor, a dynamically updating likelihood of an element control gesture being performed by a user of a first device; and providing, for display, a dynamically updating visual indicator of the dynamically updating likelihood of the element control gesture being performed by the user.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
obtaining sensor data from a sensor;
obtaining, responsive to providing the sensor data to a machine learning system, an output from the machine learning system, the output indicating one or more predicted gestures and one or more respective probabilities of the one or more predicted gestures;
determining, based on the output of the machine learning system and a gesture-detection factor, a likelihood of an element control gesture being performed by a user of a device comprising the sensor; and
activating, based on the likelihood and the gesture-detection factor, gesture-based control of an element according to the element control gesture.

2. The method of claim 1, wherein the gesture-detection factor comprises a gesture-detection sensitivity threshold or a likelihood adjustment factor.

3. The method of claim 2, wherein activating the gesture-based control of the element based on the likelihood and the gesture-detection factor comprises activating the gesture-based control of the element based on a comparison of the likelihood with the gesture-detection sensitivity threshold.

4. The method of claim 3, wherein determining the likelihood based on the output and the gesture-detection factor comprises:
determining that a first one of the one or more respective probabilities that corresponds to the element control gesture is a highest one of the one or more respective probabilities; and
increasing the likelihood by an amount corresponding to a higher of the first one of the one or more respective probabilities and a fraction of the gesture-detection sensitivity threshold.

5. The method of claim 4, wherein determining the likelihood based on the output and the gesture-detection factor further comprises:
after determining that the first one of the one or more respective probabilities that corresponds to the element control gesture is the highest one of the one or more respective probabilities, determining that a second one of the one or more respective probabilities that corresponds to a gesture other than the element control gesture is the highest one of the one or more respective probabilities; and
decreasing the likelihood by an amount corresponding to a higher of the second one of the one or more respective probabilities and a fraction of the gesture-detection sensitivity threshold.

6. The method of claim 2, further comprising:
obtaining motion information from a motion sensor of the device; and
modifying the gesture-detection sensitivity threshold based on the motion information.

7. The method of claim 6, wherein modifying the gesture-detection sensitivity threshold comprises decreasing the gesture-detection sensitivity threshold responsive to an increase in motion of the device indicted by the motion information.

8. The method of claim 7, wherein modifying the gesture-detection sensitivity threshold based on the motion information comprises modifying the gesture-detection sensitivity threshold based on the motion information upon activation of the gesture-based control, the method further comprising:
deactivating the gesture-based control; and
smoothly increasing the gesture-detection sensitivity threshold to an initial value after deactivating the gesture-based control.

9. The method of claim 1, wherein the element control gesture comprises a pinch-and-hold gesture.

10. The method of claim 1, wherein the element comprises a virtual knob, a virtual dial, a virtual slider, or a virtual remote control.

11. The method of claim 1, wherein obtaining the sensor data from the sensor comprises obtaining first sensor data from a first sensor of the device, the method further comprising obtaining second sensor data from a second sensor of the device, wherein obtaining the output indicating the one or more predicted gestures and the one or more respective probabilities of the one or more predicted gestures comprises:
providing the first sensor data to a first machine learning model trained to extract first features from a first type of sensor data;
providing the second sensor data to a second machine learning model trained to extract second features from a second type of sensor data;
combining a first output of the first machine learning model with a second output of the second machine learning model to generate a combined sensor input; and
obtaining the output indicating the one or more predicted gestures and the one or more respective probabilities of the one or more predicted gestures from a third machine learning model responsive to providing the combined sensor input to the third machine learning model.

12. The method of claim 11, wherein the first sensor data has a first characteristic amount of noise and the second sensor data has a second characteristic amount of noise higher than the first characteristic amount of noise, and wherein the machine learning system comprises at least one processing module interposed between the third machine learning model and the first and second machine learning models, the at least one processing module configured to emphasize the second sensor data having the second characteristic amount of noise higher than the first characteristic amount of noise.

13. The method of claim 1, wherein the device comprises a first device, and wherein activating the gesture-based control of the element according to the element control gesture comprises activating the gesture-based control of the element at the first device or at a second device different from the first device, and wherein the method further comprises providing, by the first device or the second device, at least one of a visual indicator based on the likelihood, a haptic indicator based on the likelihood, or an auditory indicator based on the likelihood.

14. The method of claim 1, further comprising:
detecting motion of the device greater than a threshold amount of motion; and
disabling the gesture-based control of the element while the motion of the device is greater than the threshold amount of motion.

15. A method, comprising:
obtaining sensor data from a sensor of a device over a period of time;
obtaining, based in part on providing the sensor data to a gesture control system comprising a machine learning system that is trained to identify one or more predicted gestures, a dynamically updating likelihood of an element control gesture being performed by a user of the device; and
providing, for display, a dynamically updating visual indicator of the dynamically updating likelihood of the element control gesture being performed by the user.

16. The method of claim 15, wherein providing the dynamically updating visual indicator comprises dynamically scaling an overall size of the visual indicator with the dynamically updating likelihood.

17. The method of claim 16, wherein dynamically scaling the overall size of the visual indicator with the dynamically updating likelihood comprises:
determining an increased or decreased likelihood of the element control gesture being performed by the user of the device; and
increasing or decreasing the overall size of the visual indicator according to the increased or decreased likelihood.

18. The method of claim 16, wherein the dynamically updating visual indicator comprises a plurality of distinct visual indicator components having a plurality of respective component sizes, and wherein providing the dynamically updating visual indicator further comprises dynamically varying the plurality of respective component sizes by an amount that scales inversely with the dynamically updating likelihood.

19. The method of claim 18, further comprising determining that the dynamically updating likelihood exceeds a threshold likelihood and, responsively:
setting the overall size of the visual indicator to a maximum overall size;
setting the plurality of respective component sizes to a maximum overall component size; and
activating gesture-based control of an element according to the element control gesture, wherein providing the dynamically updating visual indicator for display comprises providing the dynamically updating visual indicator for display at the device or at a second device different from the device, and wherein the element comprises an element at the device, the second device different from the device, or a third device different from the device and the second device.

20. The method of claim 19, wherein setting the plurality of respective component sizes to the maximum overall component size comprises setting a subset of the plurality of respective component sizes of a respective subset of the plurality of distinct visual indicator components to a first maximum overall component size that is larger than a second maximum component size of a remainder of the plurality of respective component sizes.

21. The method of claim 20, wherein the respective subset of the plurality of distinct visual indicator components have a location within the visual indicator, the location corresponding to an orientation of the element control gesture being performed by the user.

22. The method of claim 21, further comprising:
dynamically determining a changing orientation of the element control gesture; and
modifying the location of the respective subset of the plurality of distinct visual indicator components based on the changing orientation.

23. The method of claim 22, further comprising effecting the gesture-based control of the element according to the changing orientation.

24. The method of claim 22, wherein the visual indicator further comprises an indicator of a current setting of the element, and wherein effecting the gesture-based control of the element comprises dynamically updating a location of the indicator by an amount that corresponds to an amount of change of the changing orientation relative to an initial orientation of the element control gesture when the dynamically updating likelihood reaches the threshold likelihood.

25. The method of claim 22, wherein the visual indicator further comprises an indicator of a current setting of the element, and wherein effecting the gesture-based control of the element comprises dynamically updating a location of the indicator based on a difference between the location of the indicator and the orientation of the element control gesture.

26. The method of claim 19, further comprising a providing a confirmatory animation of the visual indicator when the dynamically updating likelihood reaches the threshold likelihood.

27. A method, comprising:
obtaining sensor data from a sensor;
obtaining, responsive to providing the sensor data to a machine learning system, an output from the machine learning system, the output indicating one or more predicted gestures and one or more respective probabilities of the one or more predicted gestures;
determining, based on the output of the machine learning system and a gesture-detection factor, a dynamically updating likelihood of an element control gesture being performed by a user of a first device; and
providing, for display, a dynamically updating visual indicator of the dynamically updating likelihood of the element control gesture being performed by the user.

28. The method of claim 27, further comprising performing gesture control of an element at the first device or a second device different from the first device.
